(19) United States
(12) Patent Application Publication
(10) Pub. No.: US 2024/0185614 A1
(43) Pub. Date: Jun. 6, 2024

(54) SYSTEM AND METHODS FOR AUTOMATED ROADWAY ASSET IDENTIFICATION AND TRACKING

(71) Applicant: Georgia Tech Research Corporation, Atlanta, GA (US)

(72) Inventors: Xinan Zhang, Atlanta, GA (US); Yung-an Hsieh, Atlanta, GA (US); ShuHo Chou, Atlanta, GA (US); Yichang Tsai, Atlanta, GA (US)

(21) Appl. No.: 18/528,962

(22) Filed: Dec. 5, 2023

Related U.S. Application Data
(60) Provisional application No. 63/386,150, filed on Dec. 5, 2022.

(51) Int. Cl. G06V 20/58; G06N 3/0464; G06T 7/70; G06V 10/25; G06V 10/26; G06V 10/82

(52) U.S. Cl. CPC G06V 20/58; G06N 3/0464; G06T 7/70; G06V 10/25; G06V 10/267; G06V 10/82; G06T 2200/24; G06T 2207/10016; G06T 2207/20084; G06T 2207/20221; G06T 2207/30252

(57) ABSTRACT

A system for automated roadway asset management obtains image data of a physical scene including a roadway; detects, by executing a machine learning model, roadway objects in the image data; determines, by executing the machine learning model, a position of the detected roadway object(s) in the image data; joins a position of the roadway object(s) between two or more images/frames to generate a multi-frame representation of the roadway object(s); determines a number of instances of the roadway object(s), e.g., over a predefined region of the roadway; and outputs, via a user interface, an indication of the determined number of instances of the roadway object(s), wherein the determined number of instances is used for inventory management of assets at the roadway.

### CROSS-REFERENCE TO RELATED APPLICATIONS

This application claims the benefit of and priority to U.S. Provisional Patent App. No. 63/386,150, filed Dec. 5, 2022, which is incorporated herein by reference in its entirety.

### BACKGROUND

A transportation system involves many physical facilities (e.g., assets) that enable it to support the mobility of people, goods, and vehicles. Roadway pavements and bridges are among the most valuable components of transportation assets. Other facilities (e.g., ancillary assets), such as signs, signals, pavement markings, guardrails, crash attenuators, rumble strips, central cable barriers, retaining walls, and noise barriers, also play unique and indispensable roles in providing smooth, safe, and efficient transportation services. However, transportation asset management has generally and historically less focused on ancillary assets compared to pavements and bridges. Although maintaining these ancillary assets may be less expensive than pavements and bridges, and their failure rates might be low, the consequences of their malfunction or failure can be costly and fatal. These elements have been proven to play an important role in roadway safety. Thus, it is beneficial to implement transportation asset management, including asset detection, inventory, condition assessment, and maintenance decision-making, in ancillary transportation assets for a safer and more cost-effective transportation system.

### SUMMARY

One implementation of the present disclosure is a system including: at least one processor; and memory having instructions stored thereon that, when executed by the at least one processor, cause the system to: obtain image data of a physical scene having a roadway, wherein the image data includes still images or video frames; detect, by executing a trained machine learning model, a roadway object in the image data, including a contiguous roadway object that spans across a plurality of the still images or video frames, the roadway object detected from among a set of predefined roadway objects on which the trained machine learning model is trained to detect; determine, by executing the trained machine learning model, a position of the detected roadway object in the plurality of still images or video frames, including of the contiguous roadway object; join a first determined position of the roadway object in a first one of the plurality of still images or video frames and a second determined position of the roadway object in a second one of the plurality of still images or video frames to generate a multi-frame representation of the roadway object; determine a number of instances of the roadway object over a predefined region of the roadway; and output, via a user interface, an indication of the determined number of instances of the roadway object, wherein the determined number of instances is used for inventory management of assets at the roadway.

Another implementation of the present disclosure is a method to automate inventory management of roadway assets, the method including: obtaining, by a processing device, image data of a physical scene having a roadway, wherein the image data includes still images or video frames; detecting, by the processing device, by executing a trained machine learning model, a roadway object in the image data, including a contiguous roadway object that spans across a plurality of the still images or video frames, the roadway object detected from among a set of predefined roadway objects on which the trained machine learning model is trained to detect; determining, by the processing device, by executing the trained machine learning model, a position of the detected roadway object in the plurality of still images or video frames, including of the contiguous roadway object; joining, by the processing device, a first determined position of the roadway object in a first one of the plurality of still images or video frames and a second determined position of the roadway object in a second one of the plurality of still images or video frames to generate a multi-frame representation of the roadway object; determining, by the processing device, a number of instances of the roadway object over a predefined region of the roadway; and output, by the processing device, via a user interface, an indication of the determined number of instances of the roadway object, wherein the determined number of instances is used for inventory management of assets at the roadway.

Yet another implementation of the present disclosure is a non-transitory computer readable medium having instructions stored thereon that, when executed by at least one processor, cause a device to: obtain image data of a physical scene having a roadway, wherein the image data includes still images or video frames; detect, by executing a trained machine learning model, a roadway object in the image data, including a contiguous roadway object that spans across a plurality of the still images or video frames, the roadway object detected from among a set of predefined roadway objects on which the trained machine learning model is trained to detect; determine, by executing the trained machine learning model, a position of the detected roadway object in the plurality of still images or video frames, including of the contiguous roadway object; join a first determined position of the roadway object in a first one of the plurality of still images or video frames and a second determined position of the roadway object in a second one of the plurality of still images or video frames to generate a multi-frame representation of the roadway object; determine a number of instances of the roadway object over a predefined region of the roadway; and output, via a user interface, an indication of the determined number of instances of the roadway object, wherein the determined number of instances is used for inventory management of assets at the roadway.

Additional features will be set forth in part in the description which follows or may be learned by practice. The features will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a diagram of a pipeline for detecting, classifying, segmenting, and tracking objects of different classes and/or types, according to some implementations.

FIG. 2 is a block diagram of a system for automated transportation asset inventorying, according to some implementations.

FIG. 3A is a diagram of the structure of an example mask recurrent convolutional neural network (Mask-RCNN) model, according to some implementations.

FIG. 3B is a diagram of the structure of an example Mask-RCNN model with a generic region-of-interest extractor (GRoIE), according to some implementations.

FIG. 4A is a diagram of an example convolutional neural network (CNN) based architecture with a generic form of self-attention, according to some implementations.

FIG. 4B is a diagram of an example architecture of a global context (GC) block, according to some implementations.

FIG. 5 is a diagram of example comparisons between intersection over union non-maximum suppression (IoU-NMS), intersection over the minimum area merging (IoMA)-NMS, and IoMA-Merging, according to some implementations.

FIG. 6 is a block diagram of a system for detecting and segmenting multiple objects of different classes and types, according to some implementations.

FIG. 7 is a flowchart of a process for objection detection and segmentation, according to some implementations.

FIG. 8 is a flowchart of a process for generating an inventory of roadway objects, according to some implementations.

FIG. 9 is an image of an example experimental setup attached to a vehicle, according to some implementations.

FIGS. 10A-10B are images of a section of highway selected for experimentation, according to some implementations.

FIG. 11 is an example of the roadway images collected during experimentation, according to some implementations.

FIGS. 12A-12B are images demonstrating the tracking of an example asset between frames, according to some implementations.

FIG. 13 is an example linear retaining wall created and mapped in a geographic information system (GIS) map, according to some implementations.

FIG. 14 is an example GIS map of retaining walls along the section of highway selected for experimentation, according to some implementations.

FIGS. 15A-15B are images of an example falsely recognized asset, according to some implementations.

FIGS. 16A-16B are images of an example double-counted asset, according to some implementations.

FIG. 17 is an image illustrating a discrepancy in asset measurements, according to some implementations.

FIGS. 18A-18B are images illustrating the measurement of assets using a semi-automatic method, according to some implementations.

FIGS. 19A-19B are additional example images of roadway assets captured during experimentation, according to some implementations.

FIG. 20 is a comparison of asset prediction results using different predictive models before post-processing, according to some implementations.

FIG. 21 is a comparison of asset prediction results using different predictive models after post-processing, according to some implementations.

FIG. 22 is a comparison between a prediction developed using the system and methods described herein and the ground truth, according to some implementations.

Various objects, aspects, and features of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a system and methods for automatically detecting and segmenting multiple objects of different classes and types from image data are shown, according to various implementations. Notably, the system and methods described herein can detect and segment objects that are overlapping in an image or video frame, e.g., for inventorying of such objects. With respect to the inventory of transportation assets (also referred to herein as “roadway objects” or “roadway assets”), for example, retaining walls, noise barriers, rumble strips, guardrails, guard-rail anchors, and central cable barriers can be detected, segmented, and tracked for an inventory management application using a single set of the acquired image or video data from standard camera or sensors. As described in greater detail below, the system and methods described herein implement machine learning-based detection, segmentation, and tracking operations using clustering.

### Overview

CNNs are often used for the classification and detection of objects, e.g., in inventory management. In certain real-world applications, objects are captured via video or sensors that show them overlapping in the acquired image. Artificial intelligence (AI) predictions or classifications of objects in such applications can generate overlapping predictions that can affect the overall predictive performance of an AI system. As an example, roadway assets, including retaining walls, noise barriers, rumble strips, guardrails, guard-rail anchors, and central cable barriers, are important roadside safety hardware and geotechnical structures. There is interest in being able to inventory roadway assets accurately to support asset management applications and ensure roadway safety. Images or videos of roadways can produce such overlapping predictions.

Traditionally, detailed information relating to ancillary roadway assets (e.g., signs, signals, pavement markings, guardrails, crash attenuators, rumble strips, central cable barriers, retaining walls, noise barriers, etc.) is acquired through a field survey or a video-based visual inspection, which is time-consuming, costly, and labor-intensive. In recent years, several studies have been conducted to develop automated roadway asset detection methods. Early studies focused on the development of conventional image processing or traditional machine learning-based methods. One study (“Study A”), for example, proposed a line detection-based pipeline to detect guardrails from two-dimensional (2D) images based on the Hough transform algorithm. Another study (“Study B”) made use of 3D data collected by LiDAR to detect the sweeps of guardrails with their guardrail tracing algorithm and further determine the locations of guardrails. Yet another study (“Study C”) proposed a pipeline to segment roadway assets at the pixel level by exploiting the Texton Forest classifier and further assigning classes to reconstructed 3D cloud points. However, these studies heavily rely on customized pipelines and hence lack flexibility. For example, the line detection-based algorithm used in Study A fails in detecting guardrails around curves. The guardrail tracing algorithm of Study B uses discontinuity detection to segment scan lines and then must devote efforts to the result examination and refinement, meaning that a customized pipeline is needed; hence the algorithm lacks flexibility in real cases because of the strict criteria posed by the pipeline.

In recent years, deep learning models have been developed with improved flexibility and detection accuracy. One more recent study (“Study D”) took advantage of a CNN to classify rumble strips within a long distance and with promising results. However, Study D still uses some pipelined schemes to assist the whole process, and the power of CNN is only used to a limited extent, which is only used to classify image patches extracted from video logs by a pipeline composed of traditional methods. This application of CNN is insufficient because detection proposals and characterization still depend on a customized pipeline including Hough transform, fast Fourier transform (FFT), etc. Another more recent study (“Study E”) developed an oriented object detection model based on YOLOv3 to detect multiple types of ancillary roadway assets, including marking, barriers, curbs, etc., with rotatable bounding boxes. However, Study E only achieved a coarse detection of the roadway assets by predicting the bounding boxes that enclose them. Thus, the current methods did not provide detailed and accurate localization information. Consequently, these methods cannot provide accurate inventory information on these assets, such as the beginning and end of the retaining walls, their heights, etc. This information is important for the management of these roadside safety assets. Also, the potential methodologies and challenges of pixel-level detection, or segmentation, of the roadway assets are still left unexplored.

In addition to the feasibility of realizing the objective, the detection and segmentation of roadway assets consist of two more major challenges. Firstly, the instances of roadway assets can appear in the image with diverse scales. The scale differences not only occur in different types of roadway assets, such as noise barriers and guardrail anchors but also occur in the same type of roadway assets that are at different distances. Secondly, large numbers of roadway assets appear continuously along the side of the roadway, such as guardrails and central cable barriers. This can lead to models generating multiple overlapping bounding boxes and segmentation masks along a single instance of the roadway asset. Although these bounding boxes and masks do correctly cover a portion of the roadway asset, they can lead to difficulties in subsequent analyses of the detected roadway assets, such as recording the number of presented roadway assets.

To address these and other shortcomings of previously developed methods, the disclosed system and methods implement unique machine learning-based automated asset detection and segmentation techniques. Notably, the system and methods described herein can be adapted for detecting, segmenting, and/or tracking roadway assets, which is the primary example provided herein. However, it should be appreciated that the disclosed system and methods can be used to detect, segment, and/or track any type(s) of objects/assets; particularly, multiple objects of different classes and types.

As an example, the disclosed system and methods can be used to evaluate the hundreds of thousands of emerging professional videos on the Internet every day, e.g., to identify and analyze objects of interest. In another example, the disclosed system and methods can be employed for auto-tracking in camera systems. Using the location and relative movement determined by the disclosed system and methods, cameras can auto-track objects with other control algorithms, by moving, rotating, etc. As yet another example, the disclosed system and methods can be employed for shelf inventory management. To this point, there is a rising need for warehouses to build inventory for their products on shelves. While manual inventory is possible, it can be unsafe and time-consuming. In yet another example, the disclosed system and methods can be employed for contactless checkout for smart retail. Over the past years, there has been a trend to transition from traditional retail to smart retail; self-checkout enabled by contactless checkout is an important part of it. With the disclosed system and methods, a smart basket or cart can identify the items taken outside for checkout.

The disclosed system and methods implement a CNN-based asset detection and segmentation model trained to detect multiple classes of assets (e.g., roadway assets) with both bounding boxes and pixel-level masks. The CNN-based asset detection and segmentation model is, more specifically, based on Mask-RCNN with FPN. To overcome the first challenge of roadway asset detection and segmentation, a generic region of interest extractor (GRoIE) is incorporated into the disclosed model by exploiting the attention mechanism in CNNs—referred to herein as “enhanced GRoIE.” The enhanced GRoIE enables the disclosed model to more effectively utilize multi-scale features extracted from the FPN during the extraction of the region of interest (RoI), which results in better detection and segmentation accuracy on roadway assets with diverse scales. In addition, to overcome the second challenge, a post-processing technique based on non-maximum suppression (NMS) and intersection over the minimum area (IoMA), denoted as IoMA-Merging, is disclosed. Using IoMA-Merging, the disclosed model can suppress overlapping detections and conserve the detection completeness of each roadway asset instance, which cannot be achieved by traditional NMS.

With more specificity, a first machine learning-based technique disclosed herein utilizes a Mask-RCNN model with an FPN that can perform multi-class roadway assets detection and segmentation with both bounding boxes and pixel-level masks. A second machine learning-based technique disclosed herein employs enhanced GRIE in the Mask-RCNN with FPN that can exploit the attention mechanism in CNNs to enable the CNN model to more effectively utilize multi-scale features extracted from the FPN during the extraction of RoIs. A third machine learning-based technique disclosed herein employs an IoMA merging algorithm with the GRoIE-GC to enable the AI model to effectively suppress overlapping predictions and conserve the detection completeness of each roadway asset instance.

Through experimentation, which is discussed below, it was found that the third machine learning-based technique mentioned above (e.g., employing GRoIE-GC with IoMA-Merging) can achieve performance with a significant improvement (e.g., improvement in the precision of detection by 10.0% and of segmentation by 10.7%) over the first baseline technique (e.g., employing multi-class roadway asset detection and pixel-wise segmentation model that can evaluate 2D images using Mask-RCNN with FPN). The third machine learning-based technique addresses scale diversity and the intensive continual appearance of roadway assets that could cause results with numerous false-positive detections as observed in the baseline techniques (e.g., the first and second machine learning-based techniques mentioned above).

As discussed in greater detail below, notable features of the disclosed system and methods include: (i) automated roadway asset detection and segmentation using machine learning techniques based on Mask-RCNN with FPN, which performs multi-class detection and segmentation with both bounding boxes and pixel-level masks; (ii) an enhanced GRoIE built by exploiting the attention mechanism in CNNs, which enables the disclosed model to more effectively utilize multi-scale features extracted from the FPN during the extraction of RoIs; and (iii) a new IoMA-Merging technique, which enables the disclosed model to effectively suppress overlapping predictions and conserves the detection completeness of each roadway asset instance.

### Object Detection, Segmentation, and Tracking Using Machine Learning

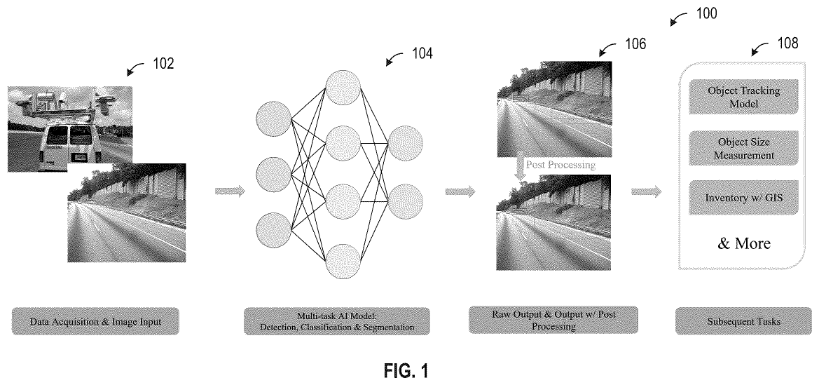

Referring first to FIG. 1, a diagram of a pipeline 100 for detecting, classifying, segmenting, and tracking objects of different classes and/or types is shown, according to some implementations. Specifically, in this example, pipeline 100 is shown to be used for detecting, classifying, segmenting, and tracking roadway assets, such as retaining walls and guardrails; however, as mentioned above, the present disclosure is not intended to be limiting in this regard. Regardless, at step 102, pipeline 100 begins with data acquisition. In the context of roadway assets, data acquisition generally refers to the collection of images of a roadway. The images can be still images or video. For example, a continuous video of a roadway may be obtained and/or a series of pictures may be collected. In addition, as discussed below, supplementary data, such as LiDAR data, may also be collected. As another example, in the context of an automated checkout, the “data” that is acquired at step 102 may be video of a checkout area or exit of a store and/or may be video collected from different areas of the store (e.g., while a customer shops).

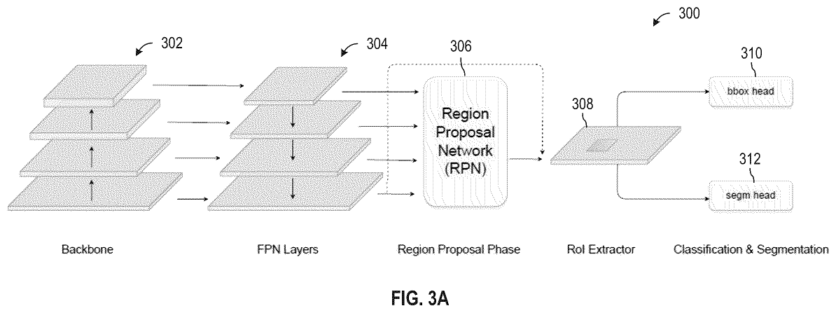

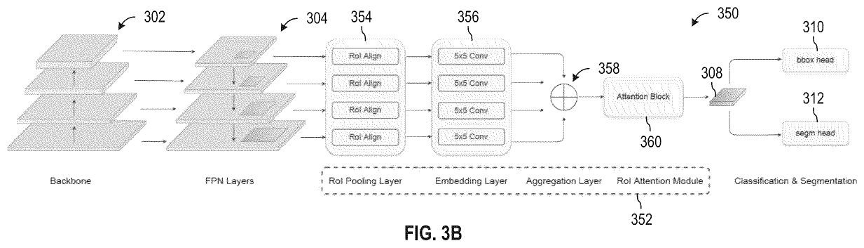

At step 104, a multi-task AI model—referred to herein as a “classification and segmentation model”—processes the collected data (e.g., images of the roadway) to detect, classify, and segment objects of interest. In other words, the classification and segmentation model is a machine learning-based predictive model, or a combination of different machine learning-based models, that is trained to detect objects of interest in image data, determine/apply a class label and/or identifier to each detected object of interest, and then segment the image data for post-processing (e.g., object tracking, as discussed below). As discussed in greater detail below, e.g., with respect to FIG. 3B, the classification and segmentation model can be a Mask-RCNN model with an enhanced GRoIE. Specifically, the enhanced GRoIE includes an RoI attention component and is enhanced to exploit a “key content only” attention factor. To realize the “key content only” attention factor, a global context (GC) block is used as instantiation. In the GC block, the attention weights depend only on key content, which generates the same attention feature for all pixels on the same feature channel. However, as also explored below, other suitable AI-based models are contemplated herein.

At step 106, the raw output of the classification and segmentation model is optionally provided, e.g., to a user via a user interface. For example, as shown, a copy of the original image/video (e.g., collected at step 102) may be displayed with overlays showing the objects of interest. In this example, the “overlays” may be representations of the bounding boxes generated by the classification and segmentation model. The bounding boxes or overlays may also indicate an identifier associated with each object of interest (e.g., an ID number and/or a label). In some implementations, at step 106, the output of the classification and segmentation model is post-processed before being presented. Post-processing can include several different techniques, as described below. In some implementations, post-processing can include a technique denoted herein as IoMA-Merging, which suppresses false-positive detections and maintains the completeness of the detected roadway assets by merging bounding boxes and/or segmentation masks that are associated with a common object. Additional discussion of IoMA-Merging is provided below.

At step 108, additional tasks can be performed using the output of the classification and segmentation model (e.g., the detected objects of interest, their class labels and/or identifiers, and the segmentation data), either with or without post-processing. One such additional processing task includes object tracking, which refers to the tracking of objects of interest between frames and/or images. In some such implementations, an object tracking model is utilized to recognize objects between images/frames and/or over time. Additionally, or alternatively, identified/tracked objects of interest can be used to build or update an asset inventory (e.g., a database of detected assets). As mentioned above, for example, roadway assets can be automatically identified and inventoried using the disclosed system and methods. Another processing task includes determining the size of one or more objects of interest based on the collected data (e.g., from step 102). For example, in some implementations, a model may be used to predict asset size from the pixels of the original image(s). Additional “subsequent” processing tasks are discussed in greater detail below.

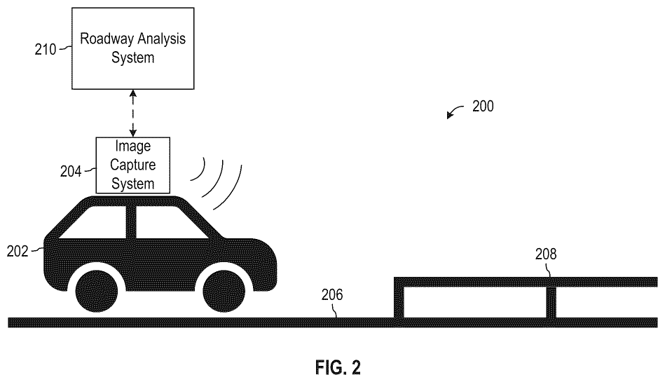

Referring now to FIG. 2, a block diagram of a system 200 for automated roadway asset inventorying is shown, according to some implementations. System 200 may, in some respects, implement pipeline 100 to identify and track roadway objects. In other words, the “objects of interest” that are detected, classified, segmented, and tracked, e.g., as described above with respect to pipeline 100, are roadway objects, such as retaining walls, guardrails, and the like. In this regard, system 200 is generally shown to include a vehicle 202 which carries an image capture system 204 configured to capture image data of a roadway 206 and, thereby, roadway assets such as a guardrail 208. As described herein, vehicle 202 may be any vehicle that is capable of traversing a roadway, such as a car, truck, or van. However, it should be appreciated that other types of vehicles may be used to carry image capture system 204, e.g., for capturing image data of a roadway. For example, vehicle 202 may instead be a drone, a plane or helicopter, or the like, and/or system 200 may instead include a series of stationary image capture devices, e.g., rather than a mobile image capture system.

Notably, guardrail 208 is an example of a contiguous roadway object; in other words, a roadway object that extends some distance along roadway 206. As will be appreciated, it can be difficult to accurately identify and track these types of contiguous roadway objects from image data since they can span multiple images or video frames, e.g., captured by image capture system 204, as discussed further below. It should also be appreciated, however, that roadway 206 and guardrail 208 are not intended to be limiting, as discussed herein. For example, roadway 206 may include any number of other assets (e.g., retaining walls, etc.), including roadway assets that are not contiguous (e.g., signs, etc.). As another example, vehicle 202 and/or image capture system 204 may be adapted to capture images of another physical scene/environment, such as a railway, a footpath, a warehouse or store, etc. Considering a warehouse, for example, vehicle 202 may be a robot or drone configured to navigate through aisles of racking.

Returning to the example shown, image capture system 204 is shown to capture image data of roadway 206—and thereby guardrail 208—as vehicle 202 is in motion. For example, vehicle 202 may be driven along a length of roadway 206 with image capture system 204 actively capturing image data. As mentioned, image data may include still images and/or video. For example, image capture system 204 may include one or more cameras configured to capture a series of images, e.g., at a set interval, or to record video (from which individual frames can be extracted). In some implementations, image capture system 204 is also configured to capture supplementary data, such as LiDAR data, to provide additional detail regarding guardrail 208 and other detected assets. As shown, in some implementations, image capture system 204 may communicate the captured image data to a roadway analysis system 210 for processing. In some such implementations, roadway analysis system 210 can be remotely located from vehicle 202 (e.g., such that image capture system 204 wirelessly transmits image data to roadway analysis system 210) or roadway analysis system 210 may be positioned within vehicle 202 (e.g., for short-range wireless or wired communications). Alternatively, roadway analysis system 210 may be integrated with image capture system 204, e.g., so that the image data is not transferred for processing.

Roadway analysis system 210 is generally configured to implement the various computer vision techniques described herein to automatically identify roadway assets (e.g., “objects of interest”) from the captured image data. In this regard, the “identification” of roadway assets generally includes detecting roadway assets of interest, classifying the detected roadway assets (e.g., determining the type of roadway asset), segmenting the roadway assets (e.g., determining a position of each asset within an image/frame of the image data), and tracking the roadway assets between images/frames. As discussed below, roadway analysis system 210 can execute a trained machine learning model for detecting, classifying, and segmenting roadway assets, such as guardrail 208. Then, various additional machine learning models can be used to perform post-processing techniques for tracking assets between images/frames, generating an inventory of assets, and the like.

Additional details regarding the identification and tracking of roadway assets are provided below; however, at a high level, roadway analysis system 210 generally provides the image data captured by image capture system 204 to the above-mentioned trained machine learning model. The machine learning model is trained, in this case, to identify specific types of roadway objects. The trained machine learning model may output, for each image or frame of the image data, an indication of the roadway objects identified and a position of each object in the image or frame. Post-processing can include joining roadway objects between images/frames. As mentioned above, for example, certain contiguous roadway objects (e.g., retaining walls) can span across multiple images or video frames; however, for the purposes of generating an asset inventory, it is desirable to avoid double-counting assets. Once the image data is processed, various information can be provided to a user. For example, the user may be presented (e.g., via a user interface) with a list of assets, a map of where the assets are located, a copy of the image/video frame having the object(s) identified therein, and the like.

As mentioned, the trained machine learning model described herein is a type of multi-task computer vision model that is configured to detect, classify, and segment multiple different objects of different types from image data. Various types of suitable machine learning—or, more broadly, AI models—are contemplated herein. FIG. 3B, discussed below, provides an example of one such model; however, the present disclosure is not intended to be limiting in this regard. Rather, various other suitable AI and machine learning models are contemplated herein.

The term “artificial intelligence” is defined herein to include any technique that enables one or more computing devices or comping systems (e.g., a machine) to mimic human intelligence. AI includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural networks or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Referring now to FIG. 3A, a diagram of the structure of an example Mask-RCNN model 300 is shown, according to some implementations. Mask-RCNN has shown significant success in object detection and segmentation, including automatic nucleus segmentation, fruit detection in automatic harvesting areas, etc. Given an input image, a backbone 302 of Mask-RCNN model 300 is responsible for extracting the contextual image features through multiple convolutional layers. Then, a region proposal network (RPN) 306 takes in the extracted features to generate bounding box proposals, which are likely to contain the searched object. The Mask-RCNN model 300 feeds the feature map from the last layer of backbone 302 to RPN 306 to generate multi-scale feature maps with different spatial resolutions from the backbone. FPN layers 304 make use of a pyramid of features as input to RPN 306, which achieves better detection performance of objects of different scales.

With the bounding box proposals, a region of interest (RoI) extractor 308 is used to extract RoIs from FPN layers 304 based on RoI pooling algorithms, such as RoI Align or RoI Warp. Finally, the RoIs are fed into a bounding box head 310 and a segmentation head 312. Bounding box head 310 generally includes a sequence of convolutional and fully connected layers to predict the coordinates of the bounding box and the corresponding class of each instance. On the other hand, segmentation head 312 generally includes convolutional layers to generate the pixel-wise segmentation mask of each instance. In the complex architecture of the Mask-RCNN with FPN, RoI extractor 308 plays a critical role since it connects RPN 306—which generates the proposed bounding boxes—with bounding box head 310 and segmentation head 312, which generate the final detection and segmentation results.

Referring now to FIG. 3B, a diagram of the structure of an example Mask-RCNN model 350 with an enhanced GRoIE is shown, according to some implementations. When selecting the single FPN layer for RoI extraction, the Mask-RCNN with FPN model (e.g., Mask-RCNN model 300) makes a hard selection of a single layer of FPN (e.g., FPN layers 304), which limits the performance of the network since the multi-scale features obtained by the FPN are not fully utilized. To achieve better results on roadway asset detection, a GRoIE 352 is incorporated in Mask-RCNN model 350, e.g., in place of RPN 306. GRoIE 352 aggregates the information from all FPN layers 304 for RoI extraction. As shown, GroIE 352 first includes an RoI pooling layer 354 that extracts RoIs from FPN layers 304. Then, the extracted RoIs are pre-processed by a convolutional layer 356. The RoIs from all branches are then aggregated by element-wise summation layer 358. Finally, a post-processing component (e.g., an attention component 360) is used as an extra elaboration step applied to the merged features before eventually returning them. In this way, semantic information from different FPN layers 304 can be utilized more efficiently.

In GRoIE 352, attention component 360 is specifically designed to help the network learn global features, with all the scales taken into account. In some implementations, attention component 31 adopts two types of CNN-based self-attention block—an ε₂ attention block and a non-local block. This enables the network to be more robust to diverse-scale objects by learning with richer global semantic information. To overcome the diverse-scale challenge in roadway asset detection and segmentation, GRoIE 352 is enhanced with a focus on attention component 360. Specifically, the system and methods described herein exploit the “key content only” attention factor for attention component 360, as discussed below.

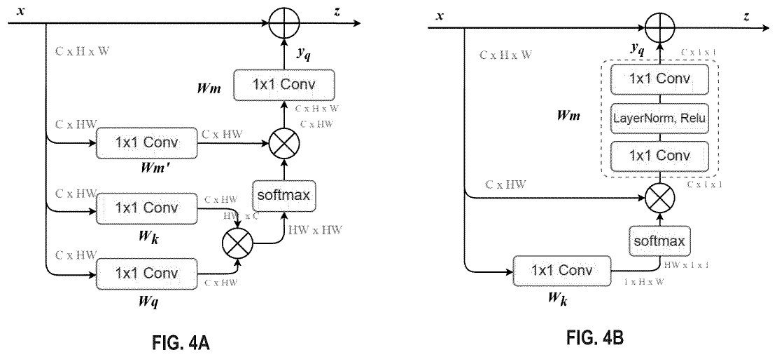

Self-attention, which captures the long-range dependencies between different positions in a sequence, has been applied to CNNs for improved visual recognition capability. One proposed a generic form of self-attention, in which the attention feature (y_{q}), can be computed in Eq. 1 as:

$${y}_{q} = {\sum }_{m = I}^{M} {W}_{m} [ {\sum }_{k ∈ {Ω}_{q}} {A}_{m} ( q , k , {z}_{q} , {x}_{k} ) ⊗ {W}_{m}^{′} {x}_{k} ]$$

where m indexes the attention head, Ω_{q} specifies the supporting key region for the query, q indexes a query element with content z_{q}, and k indexes a key element with content xₖ, Aₘ(q, k, z_{q}, xₖ) denotes the attention weights in the m-th attention head, and Wₘ and W′ₘ are learnable weights. FIG. 4A presents an exemplary CNN-based architecture of generic attention.

Based on the input properties for computing the attention weights assigned to a key with respect to a query, four common attention factors can be defined. Disclosed herein is a “key content only” (ε₃) attention factor to enhance the performance of GRoIE, which does not account for query content but rather mainly captures salient key elements. The fundamental reason is that the aggregated RoI features are a stack of small-sized feature maps with multiple channels. The regions captured by RoI features exactly contain the potential objects of interest. Therefore, each pixel position matters almost equally on each channel. However, the importance may vary by channel because each channel encodes different semantic information. Therefore, the ε₃ attention factor is more suitable for GRoIE since it can better learn query-independent attention among feature map channels without the distraction from query and position information.

To realize the ε₃ attention factor in GRoIE (e.g., GRoIE 352), a global context (GC) block is used as instantiation. Based on the generic attention equation (Eq. 1), the GC block can be formulated as Eq. 2:

$${y}_{q} = {W}_{m} [ {\sum }_{k ∈ {Ω}_{q}} \frac{f ( {x}_{k} )}{C ( x )} ⊗ {x}_{k} ] where \frac{f ( {x}_{k} )}{C ( x )}$$

is in the form of embedded Gaussian as

$$\frac{exp ( {W}_{k} {x}_{k} )}{{\sum }_{m} exp ( {W}_{k} {x}_{k} )} ,$$

and Wₘ consists of layer is in the form of embedded Gaussian as normalization, ReLU, and convolutional operations. FIG. 4B presents the architecture of the GC block. In the GC block, the attention weights only depend on key content, which generates the same attention feature for all pixels on the same feature channel. This query-independent property is lightweight and can effectively model the global context, which was found to be the most suitable attention mechanism.

Since popular object detection networks depend on anchors to generate object proposals, overlapping bounding boxes or segmentation masks are almost inevitably ubiquitous in the results. In TAM, the overlapping bounding boxes and segmentation masks along a single instance of the roadway asset can lead to difficulties in subsequent analysis. While NMS (hereafter referred to as IoU-NMS) has been a popular post-processing algorithm to suppress the redundant detections on a single instance based on the IoU metric, the scale diversity and continuous appearance of roadway assets cause the effectiveness of NMS to be insufficient. Therefore, inspired by the IoMA-NMS and Syncretic-NMS, a post-processing technique is denoted as IoMA-Merging disclosed herein, e.g., implemented by attention component 312, to suppress the false-positive (FP) detections and maintain the completeness of the detected roadway assets.

The proposed IoMA-Merging algorithm works iteratively as follows. First, given the candidate bounding boxes B=b₁, . . . ,b_{N} that belong to a single class, the algorithm greedily picks the detection with the highest classification score (Bₘ) and compares it with the remaining detections. The comparison is done by computing the IoMA between the detections using Eq. 3:

$$IoMA = \frac{area ( {B}_{i} ∩ {B}_{j} )}{min ( area ( {B}_{i} ) , area ( {B}_{j} ) )}$$

in which Bᵢ, Bⱼ are two detections given by the model. This has been shown to further suppress FP cases surviving the IoU-NMS. If the IoMA between the detections is larger than a threshold (Nₜ), the one with a lower classification score will be processed in two ways. If the score difference is within another threshold (Nₑ), the two detections will be merged to maintain the integrity of the detection on a single instance. Otherwise, the one with a lower classification score will be eliminated following the practice in IoU-NMS. This approach allows tolerance to plausible detections whose scores are lower than a highest score, thus preserving the completeness of detections on a single instance. Otherwise, it is likely that the surviving detection only encompasses a small portion of the objects of interest, with the most accurate detection and other detections eliminated.

The pseudocode of the IoMA-Merging algorithm is shown in Algorithm 1:

```
Data: A list of initial detection boxes B = {b₁,..., b_{N}}; A list of corresponding detection
scores S = s₁,..., s_{N}; Two thresholds Nₜ, Nₑ
D ← { }
while B ≠ empty do
  m ← { }
  A ← argmax(S)
  M ← bm
  D ← D ∪ M; B ← B-M
  foreach bᵢ in B do
    if IoMA(M, bᵢ) > Nₜ then
      if abs(S_{M}, Sᵢ) > Nₑ then
        A ← M, bᵢ
      end
      B ← B − bᵢ; S ← S-Sᵢ
    end
  end
  Update M in D with the minimum x₁, y₂ coordinates, the maximum y₁, x₂
  coordinates of candidates in A
end
return D,S
```

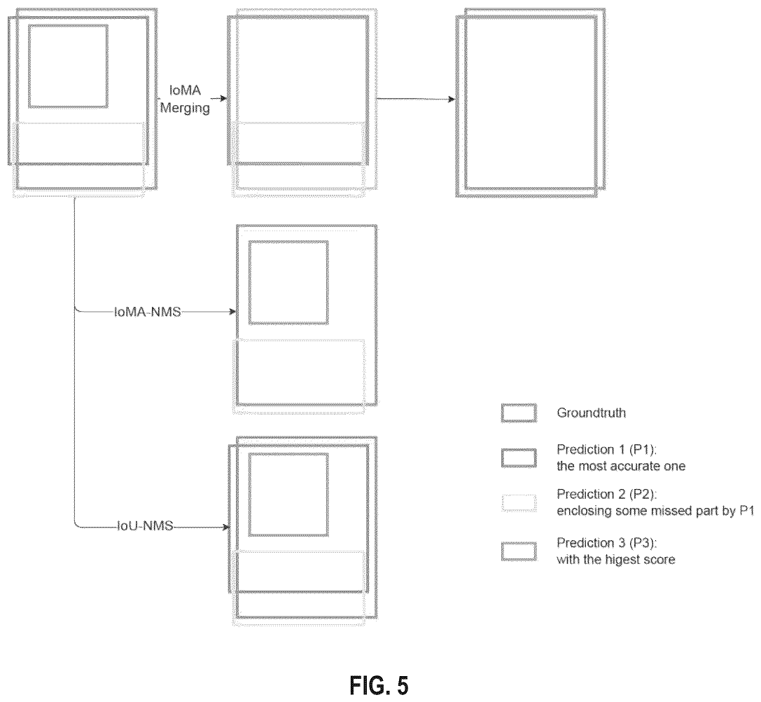

Referring now to FIG. 5, a diagram of example comparisons between intersection over union non-maximum suppression (IoU-NMS), intersection over the minimum area merging (IoMA)-NMS, and IoMA-Merging is shown, according to some implementations. FIG. 5, in particular, demonstrates an example of how the IoMA-merging works given the initial detections shown at the top-right corner. In the first iteration, the IoMA-Merging selects the detection with the highest score and computes IoMA between it and other detections. Since the IoMA is higher than the threshold (Nₜ) and their score difference is smaller than the threshold (Nₑ), the bounding box for “Prediction 1” is merged, which creates a new bounding box (“Prediction 3”). In the second iteration, the merged bounding box is selected given its high detection score. Assuming that the IoMA between the “Prediction 2” and “Prediction 3” boxes exceeds the threshold Nₜ, and the score difference is smaller than Nₑ, the bounding box associated with “Prediction 2” is also merged, which results in a single bounding box that maintains the integrity of the detection on a single instance. In IoMA-NMS, the “Prediction 1” box is eliminated given its high IoMA with respect to the “Prediction 3” box. Then, the algorithm ends since there is no overlapping between the “Prediction 3” and “Prediction 2” boxes. In IoU-NMS, no processing is performed since the IoU between all boxes is small.

### System and Methods

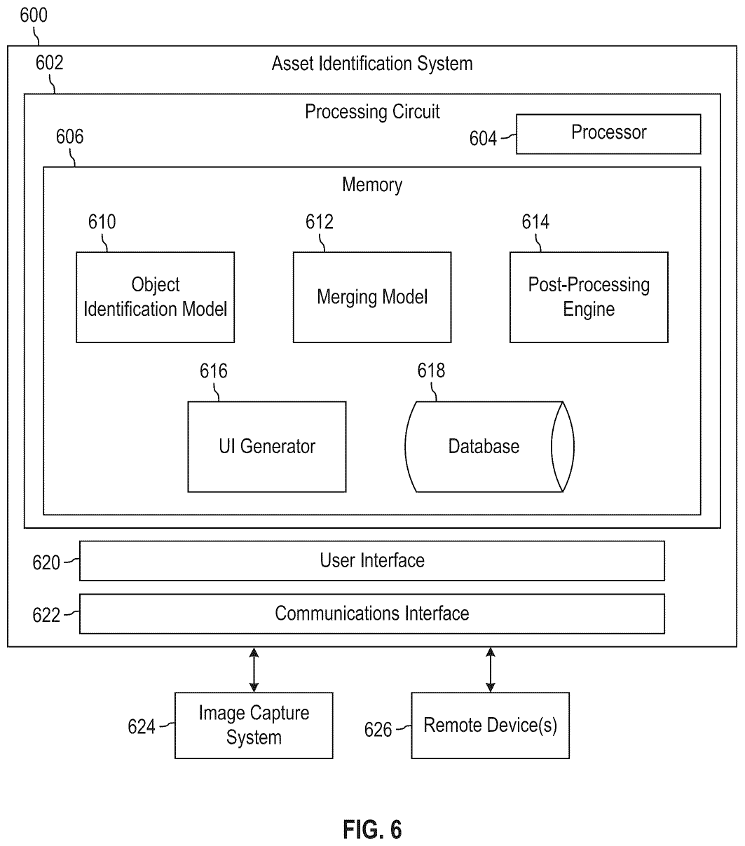

Referring now to FIG. 6, a block diagram of an “asset identification” system is shown, according to some implementations. The “asset identification” system—herein referred to as system 600—is generally configured to detect, classify, segment, and/or track multiple “objects of interest” within image data. In this regard, system 600 can be deployed in a variety of environments, e.g., to identify and track a variety of physical assets using image data (e.g., still images and/or video). For example, system 600 can be used to identify and track roadway assets for roadway management, purchasable goods in a store, inventory in a warehouse, and so on. Therefore, it should be appreciated that roadway analysis system 210, as described above with respect to FIG. 2, may refer to system 600 (e.g., roadway analysis system 210 is system 600, in some implementations).

System 600 is shown to include a processing circuit 602 that includes a processor 604 and a memory 606. Processor 604 can be a general-purpose processor, an application-specific integrated circuit (ASIC), one or more field programmable gate arrays (FPGAs), a group of processing components (e.g., a central processing unit (CPU)), or other suitable electronic processing structures. In some implementations, processor 604 is configured to execute program code stored on memory 606 to cause system 600 to perform one or more operations, as described below in greater detail. It will be appreciated that, in implementations where system 600 is part of another computing device, the components of system 600 may be shared with, or the same as, the host device. For example, if system 600 is implemented via a server (e.g., a cloud server), then system 600 may utilize the processing circuit, processor(s), and/or memory of the server to perform the functions described herein.

Memory 606 can include one or more devices (e.g., memory units, memory devices, storage devices, etc.) for storing data and/or computer code for completing and/or facilitating the various processes described in the present disclosure. In some implementations, memory 606 includes tangible (e.g., non-transitory), computer-readable media that store code or instructions executable by processor 604. Tangible, computer-readable media refers to any physical media that is capable of providing data that causes system 600 to operate in a particular fashion. Example tangible, computer-readable media may include, but is not limited to, volatile media, non-volatile media, removable media and non-removable media implemented in any method or technology for storage of information such as computer-readable instructions, data structures, program components, or other data. Accordingly, memory 606 can include random access memory (RAM), read-only memory (ROM), erasable programmable read-only memory (EPROM), electronically erasable programmable read-only memory (EEPROM), hard drive storage, temporary storage, non-volatile memory, flash memory, optical memory, or any other suitable memory for storing software objects and/or computer instructions. Memory 606 can include database components, object code components, script components, or any other type of information structure for supporting the various activities and information structures described in the present disclosure. Memory 606 can be communicably connected to processor 604, such as via processing circuit 602, and can include computer code for executing (e.g., by processor 604) one or more processes described herein.

While shown as individual components, it will be appreciated that processor 604 and/or memory 606 can be implemented using a variety of different types and quantities of processors and memory. For example, processor 604 may represent a single processing device or multiple processing devices. Similarly, memory 606 may represent a single memory device or multiple memory devices. Additionally, in some implementations, system 600 may be implemented within a single computing device (e.g., one server, one housing, etc.). In other implementations, system 600 may be distributed across multiple servers or computers (e.g., that can exist in distributed locations). For example, system 600 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by two or more computers.

Memory 606 is shown to include an object identification model 610 configured to detect, classify, and segment objects of interest from image data. As described herein, “image data” generally refers to still images and/or video of a physical environment. For example, in the context of roadway assets, image data can include video of a roadway captured from one or more cameras (e.g., positioned on a moving vehicle, as discussed above with respect to FIG. 2). In this regard, object identification model 610 generally obtains image data captured by an external device, such as an image capture system 624 (described below). For example, object identification model 610 may receive image data directly from image capture system 624 or the image data captured by image capture system 624 may be stored on an intervening device (e.g., one of remote device(s) 626) or in a database 618 for later processing. In many cases, object identification model 610 is configured to process image data in real or near real-time; thus, image data may be periodically or continuously obtained.

After being obtained, object identification model 610 evaluates the image data to detect, classify, and segment objects of interest. In other words, object identification model 610 detects objects of interest in the image data, predicts a class label for each of the objects of interest, and segments (e.g., determines a position of) the objects of interest. The “objects of interest” may vary based on the implementation of system 600; however, in the context of system 200, as described above, the “objects of interest” discussed herein may be roadway assets. Generally, as discussed above, object identification model 610 is or includes a machine learning model—or multiple machine learning models—trained to perform said detection, classification, and segmentation of the objects of interest. In this regard, object identification model 610 may be trained according to the specific objects to be detected.

In some implementations, object identification model 610 is or includes a Mask-RCNN model that has been modified to include a GRoIE with a GC block for instantiation. In other words, object identification model 610 is or includes Mask-RCNN model 350 as described above with respect to FIG. 3B. For the sake of brevity, details of Mask-RCNN model 350 are not repeated here. However, at a high level, object identification model 610 can include a plurality of convolutional layers configured to extract contextual features from the image data at a plurality of spatial resolutions. In some implementations, the plurality of convolutional layers includes one or more backbone layers (e.g., backbone 302) and one or more FPN layers (e.g., FPN layers 304). Following the plurality of convolutional layers, object identification model 610 can include a GRoIE (e.g., GRoIE 352) configured to aggregate an output of all the convolutional layers for RoI extraction. As mentioned above, the GRoIE first extracts RoIs from all FPN layers using an RoI pooling component, which is then pre-processed by a convolutional layer. Next, the RoIs from all branches are aggregated by element-wise summation. Finally, a post-processing component is used as an extra elaboration step applied to the merged features before returning them.

As discussed above, the GRoIE of object identification model 610 is notably “enhanced” the GRoIE by considering a “key content only” (ε₃) attention factor. To realize the key content only” (ε₃) attention factor, object identification model 610 includes a GC block for instantiation. The GC block can be formulated as in Eq. 2, above, and is illustrated in FIG. 4B. Following the GRoIE, object identification model 610 can include an RoI extractor (e.g., RoI extractor 308) which extracts RoIs from the output of the GRoIE. The outputs of the RoI extractor are then fed to a bounding box head and/or a segmentation head. The bounding box head, as discussed above, is configured to predict the coordinates of a bounding box and a corresponding class for each of the objects of interest. The segmentation head, also discussed above, is configured to generate a pixel-wise segmentation mask for each of the objects of interest.

It should be appreciated, however, that object identification model 610 can be another suitable type of machine learning model (or can include multiple different types of models for object detection, classification, and segmentation) in various other implementations. Thus, the present disclosure is not necessarily limited only to implementations in which object identification model 610 is a Mask-RCNN model—specifically, Mask-RCNN model 350 which includes GRoIE. Rather, any other suitable computer vision model(s) are contemplated herein, albeit with potentially poorer performance than a Mask-RCNN model with GRoIE. For example, object identification model 610 may include another type of deep learning model or another type of Mask-RCNN model that has been modified from Mask-RCNN model 350.

It should also be appreciated based on the above description that object identification model 610 is generally a “trained” machine learning model. Specifically, object identification model 610 is trained using various machine learning training techniques based on the objects of interest, e.g., to identify said objects and assign an appropriate class. Thus, it should be appreciated that system 600 may be further configured to train object identification model 610 using a training data set. Alternatively, object identification model 610 may be trained by a separate computing device. In any case, the “training data” used to train object identification model 610 can generally include annotated image data; in other words, previously captured image data that has been manually or automatically annotated to indicate the objects of interest. As will be appreciated by those in the art, object identification model 610 may evaluate the training data and make appropriate adjustments (e.g., to weights) to minimize error. Further details of the training of object identification model 610 are provided below with respect to FIGS. 19A-21.

Once objects of interest are identified (e.g., detected, classified, and segmented), a merging model 612 can be implemented to suppress the false-positive detections and maintain the completeness of the detected objects. In other words, merging model 612 can identify and merge overlapping bounding boxes and/or segmentation masks associated with a single object of interest. As discussed above with respect to FIG. 5, merging model 612 can therefore be or include an IoMA-Merging model that works by picking a bounding box or segmentation mask with the highest classification score (Bₘ) and comparing it with the other bounding boxes or segmentation masks, e.g., according to Eq. 3. If the IoMA between the detections is larger than a threshold (Nₜ), the one with a lower classification score will be processed in two ways: if the score difference is within another threshold (Nₑ), the two detections will be merged for maintaining the integrity of the detection on a single instance; otherwise, the one with a lower classification score will be eliminated following the practice in IoU-NMS. It should be appreciated, however, that this disclosure contemplates other suitable types of models and algorithms for merging corresponding bounding boxes and/or segmentation masks.

Once the objects of interest are identified and/or any overlapping bounding boxes or segmentation masks are merged, the results of the evaluation of the image data may be presented to a user, e.g., via a user interface 620. For example, as demonstrated in FIGS. 12A, 11B, 14A, or 14B, all discussed below, the bounding boxes and/or segmentation masks may be presented as an overlay to the image data (e.g., a copy of a still image or a live video feed), along with an indication of the identified object (e.g., a class/label, an identifier, a confidence score, etc.). Alternatively, or additionally, the outputs of one or both of object identification model 610 and merging model 612 may be used for further analysis by a post-processing engine 614.

Post-processing engine 614 can perform several different post-processing tasks, e.g., depending on the specific deployment of system 600. One such post-processing task is to track objects of interest using an object-tracking model. In some such implementations, the object tracking model is or includes a machine learning model trained to track objects of interest between images/frames. For example, post-processing engine 614 may implement the object tracking model to identify objects that are the same between two or more images so that they can be associated or otherwise identified as the same object. In some such implementations, the tracking model may associate a unique identifier with each object of interest so that it can be tracked between images/frames. In some implementations, post-processing engine 614 further uses a digital linear filter to facilitate continuous detection of like objects by identifying/removing noise and/or identifying missing assets. For example, if a section of a roadway is recorded at two different periods in time, post-processing engine 614 may be configured to identify any roadway assets that are newly identified and/or missing between the first and second evaluations. In some implementations, object tracking can include identifying discontinuities in a multi-frame representation of an object (e.g., between two or more images or frames) and removing a still image or video frame associated with the discontinuity.

Another post-processing task that can be performed by post-processing engine 614 is to build or update an inventory of objects of interest. In some such implementations, post-processing engine 614 can maintain an “asset inventory” in database 618. As mentioned above, for example, roadway assets can be automatically inventoried by post-processing engine 614 after being automatically identified by object identification model 610 and merging model 612. Another post-processing task includes determining the size of one or more objects of interest. For example, in some implementations, post-processing engine 614 may predict asset size from the pixels of the original image(s). Yet another post-processing task that can be performed by post-processing engine 614 is to map objects of interest, e.g., on a GIS map.

Regardless of the specific post-processing tasks that are performed, the results of post-processing and/or the other evaluations completed by object identification model 610 and/or merging model 612 may be presented via user interface 620, as mentioned above. In some implementations, memory 606 includes a user interface generator 616 configured to generate graphical user interfaces (GUI) to present said information. For example, as mentioned above, user interface generator 616 may be configured to generate a GUI that overlays the bounding boxes and/or segmentation masks of one or more objects one the image data (e.g., a copy of a still image or a live video feed), along with an indication of the identified object (e.g., a class/label, an identifier, a confidence score, etc.). As another example, user interface generator 616 may generate a GUI that indicates the objects of interest on a map. In yet another example, user interface generator 616 may generate a GUI that displays a list of inventoried assets.

System 600 is further shown to include a communications interface 622 that facilitates communications (e.g., transmitting data to and/or receiving data from) between system 600 and any external components or devices, including image capture system 624 and/or remote device(s) 626. Accordingly, communications interface 622 can be or can include any configuration of wired and/or wireless communications interfaces (e.g., jacks, antennas, transmitters, receivers, transceivers, wire terminals, etc.) for conducting data communications, or a combination of wired and wireless communication interfaces. In some implementations, communications via communications interface 622 are direct (e.g., local wired or wireless communications) or via a network (e.g., a WAN, the Internet, a cellular network, etc.). For example, communications interface 622 may include one or more Ethernet ports for communicably coupling system 600 to a network (e.g., the Internet). In another example, communications interface 622 can include a Wi-Fi transceiver for communicating via a wireless communications network. In yet another example, communications interface 622 may include cellular or mobile phone communications transceivers.

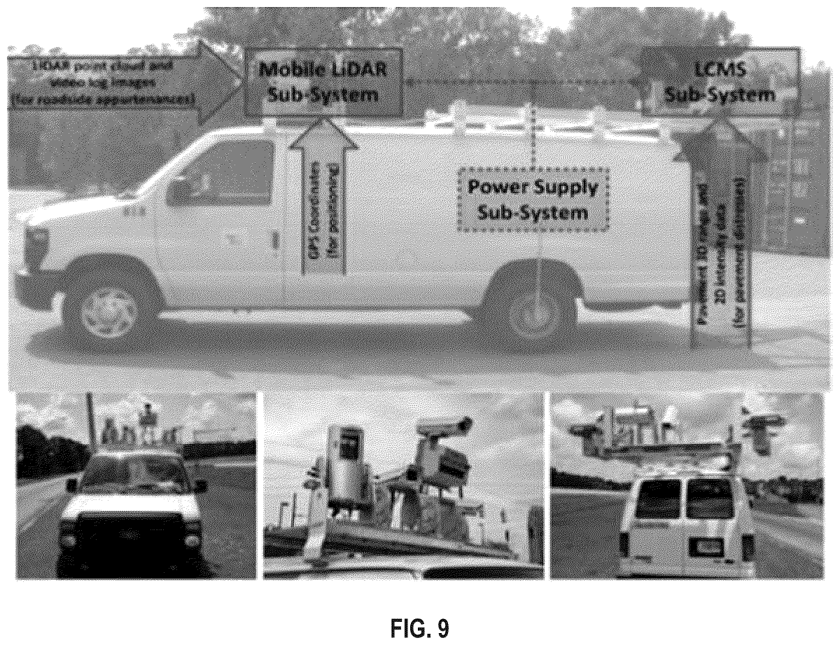

Image capture system 624, as mentioned above, is generally configured to capture the image data that is processed by system 600, e.g., to identify objects of interest. Accordingly, image capture system 624 can include any number and/or type of image capture devices. For example, image capture system 624 can include one or more cameras or other types of sensors for capturing images or video. To this point, image capture system 624 may be the same as or equivalent to image capture system 204, as described above with respect to FIG. 2. As described below with respect to FIG. 9, for example, image capture system 624 may include one or more cameras mounted to a vehicle for collecting images (e.g., video or a series of still images) of a roadway while the vehicle is in motion. In some implementations, image capture system 624 can be configured to capture supplementary image data, such as LiDAR data, infrared images, and the like. In some implementations, image capture system 624 can be at least partially controlled based on the objects of interest that are identified/tracked by system 600. For example, image capture system 624 could articulate one or more cameras to track an identified object of interest.

Remote devices(s) 626 can include one or more computing devices that are remote/external from system 600. Examples of such devices include, but are not limited to, additional computers, servers, printers, displays, and the like. In some implementations, as mentioned above, remote device(s) 626 includes a display for presenting user interfaces, e.g., including the information generated by system 600. For example, system 600 could transmit a generated inventory of assets to remote device(s) 626 to update a remote database, store the inventory, perform additional processing, and the like. In some implementations, as with image capture system 624, remote device(s) 626 include devices that can be controlled based on the objects of interest that are identified/tracked by system 600. For example, remote device(s) 626 could include a camera system that includes actuators for moving one or more cameras, in which case the camera system may utilize the output of system 600 to track objects of interest in real-time (e.g., by moving the one or more cameras to adjust a field of view). As another example, remote device(s) 626 may include inventory-control robots within a warehouse that utilize the output of system 600 to identify and track inventory.

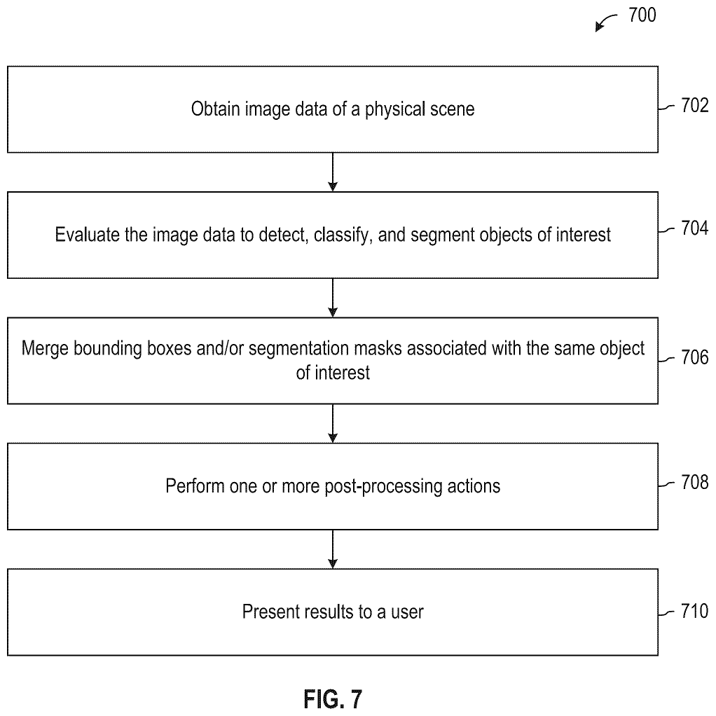

Referring now to FIG. 7, a process 700 for objection detection, classification, segmentation, and/or tracking, according to some implementations. As discussed above with respect to system 600, process 700 likewise enables the detection, classification, segmentation, and/or tracking of multiple objects of different classes and types by implementing the classification and segmentation model(s) (e.g., Mask-RCNN model 300, described with respect to FIG. 3B) and the IoMA-Merging technique described above. To this point, in some implementations, process 700 is implemented by system 600, as described above. It will be appreciated that certain steps of process 700 may be optional and, in some implementations, process 700 may be implemented using less than all of the steps. It will also be appreciated that the order of steps shown in FIG. 7 is not intended to be limiting.

At step 702, image data of a physical environment is obtained. As discussed above, image data generally refers to still images and/or video of the physical environment. The physical environment may be any real-world environment, such as a roadway, a warehouse, a store, or the like. Image data may be received or captured by any number of image capture devices, such as one or more cameras. In the context of roadway assets, image data may include video or a series of still images captured by one or more cameras mounted on a moving vehicle.

At step 704, the image data is evaluated to detect, classify, and segment objects of interest. Generally, as described above, the image data is evaluated by (e.g., provided as an input to) a trained machine learning model. In some implementations, the trained machine learning model is a Mask-RCNN model or, more specifically, a Mask-RCNN model that has been modified with an enhanced GRoIE. The trained machine learning model outputs bounding boxes and/or segmentation masks associated with each detected object of interest, along with an identifier for each object (e.g., a class label and/or identification number) and a confidence score in the classification.

At step 706, two or more bounding boxes and/or segmentation masks that are associated with a single object of interest are merged. Specifically, in some implementations, an IoMA-Merging model is further used to merge the two or more bounding boxes and/or segmentation masks. For example, if two bounding boxes are each associated with the same guardrail, the IoMA-Merging model may merge the bounding boxes as discussed above. As mentioned above, the IoMA-Merging model that works by picking a bounding box or segmentation mask with a highest classification score (Bₘ) and comparing it with the other bounding boxes or segmentation masks, e.g., according to Eq. 3. If the IoMA between the detections is larger than a threshold (Nₜ), the one with a lower classification score will be processed in two ways: if the score difference is within another threshold (Nₑ), the two detections will be merged for maintaining the integrity of the detection on a single instance; otherwise, the one with a lower classification score will be eliminated following the practice in IoU-NMS.

At step 708, one or more post-processing tasks are performed using the evaluated image data. As mentioned above, a number of different post-processing tasks are contemplated herein, including tracking objects of interest between two or more images so that they can be associated or otherwise identified as the same object, applying a linear filter to facilitate continuous detection of like objects to identify/remove noise and/or identify missing assets, building or updating an inventory of objects of interest, and/or determining the size of one or more objects of interest. With respect to tracking objects of interest, it should be noted that image data may be periodically or continuously obtained (e.g., as in step 702) and evaluated (e.g., as in steps 704, 706); thus, objects can be tracked across multiple images.

At step 710, results are presented to a user. In some implementations, the results are presented to a user via a user interface that overlays the bounding boxes and/or segmentation masks of one or more objects one the image data (e.g., a copy of a still image or a live video feed). In some such implementations, the user interface includes an indication of the identified object (e.g., a class/label, an identifier, a confidence score, etc.). In some implementations, the objects of interest may be indicated on a map or within a building layout. In some implementations, a list of inventoried assets is presented to the user. For example, the inventory can be displayed on a user interface, printed, etc.

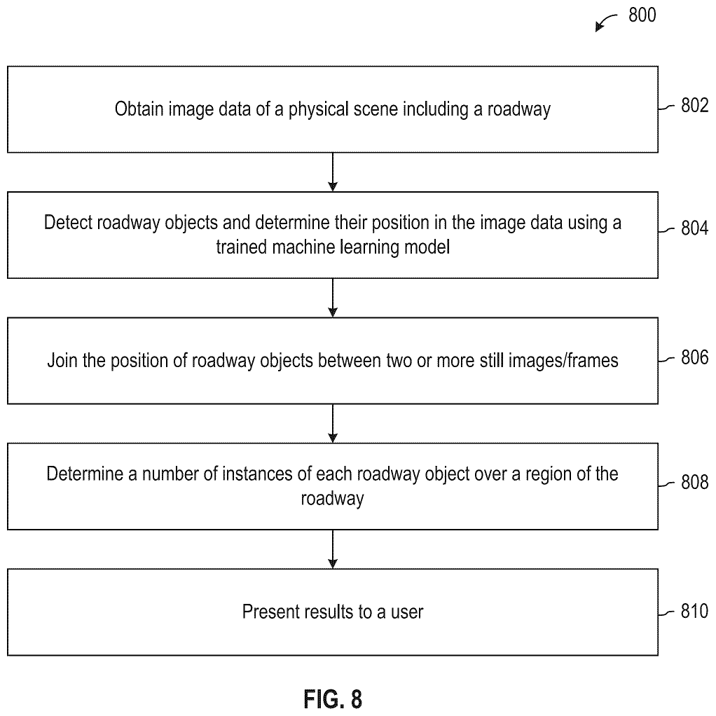

Referring now to FIG. 8, a flowchart of a process 800 for generating an inventory of roadway objects is shown, according to some implementations. In this regard, process 800 may be a specific application of the methods described herein, e.g., as discussed above with respect to system 200. In some implementations, process 800 is implemented by system 600, as described above. It will be appreciated that certain steps of process 800 may be optional and, in some implementations, process 800 may be implemented using less than all of the steps. It will also be appreciated that the order of steps shown in FIG. 8 is not intended to be limiting.

At step 802, image data of a physical scene including a roadway is obtained. As discussed above, image data generally refers to still images and/or video of the roadway. Notably, image data can refer to a series of still images and/or a series of frames obtained from video, in some implementations. Regardless, image data may be received or captured by any number of image capture devices, such as one or more cameras. In the context of roadway assets, image data may include video or a series of still images captured by one or more cameras mounted to a moving vehicle, as shown in FIG. 2. For example, video or a series of still images may be captured as the vehicle traverses a section of the roadway. Notably, the image data may contain contiguous roadway objects, e.g., that are present in (“span”) multiple images/frames.

At step 804, roadway objects are detected from the image data and the position of each identified roadway object within the image(s) is determined. In this regard, step 804 can generally include evaluating the image data captured at step 802 using a trained machine learning model. For example, in some implementations, step 804 may generally encompass one or more steps of process 700, as discussed above. More generally, the image data may be provided as an input to the trained machine learning model, which outputs bounding boxes and/or segmentation masks identifying each roadway object and it's associated position within an image (e.g., one image or frame of the image data). As discussed above, the trained machine learning model internally detects roadway objects associated with a set of predefined roadway objects, classifies the roadway objects according to class associated with the set of predefined roadway objects, and segments the roadway objects (e.g., to identify their location in the image). In some implementations, the trained machine learning model described herein is a Mask-RCNN model or, more specifically, a Mask-RCNN model that has been modified with an enhanced GRoIE. However, as mentioned above, other types of AI models for computer vision are also contemplated.

At step 806, the position of roadways objects that span multiple images/frames are joined. In other words, roadways objects may be tracked between images/frames, e.g., so that contiguous objects or objects that appear in multiple images/frames are only identified once (e.g., not double counted). As an example, the first determined position of a roadway object in a first one of the plurality of still images or video frames and a second determined position of the roadway object in a second one of the plurality of still images or video frames may be joined to generate a multi-frame representation of the roadway object. As mentioned above, this correlation may be performed using one or more post-processing techniques. In some implementations, a tracking model is executed to identify and join objects that appear in multiple frames. In some implementations, joining the position of an object between two or more images/frames can further include identifying a discontinuity in the multi-frame representation of the roadway object, e.g., between a first images or video frames and a second images or video frames, and then removing a still image or video frame associated with the discontinuity, as discussed above.

At step 808, a number of instances of each roadway object is determined, e.g., over a predefined region of the roadway. In other words, the number of each type of roadway object over the predefined region of the roadway may be counted, e.g., for purposes of inventory management. As an example, consider a scenario in which four distinct retaining walls are identified along a ten-mile stretch of highway; in this case, the number of instances of “retaining wall” is four. Notably, the number of instances of different types of roadway objects may be simultaneously determined. In some implementations, in addition

In some implementations, process 800 can include additional steps (not shown) of post-processing the image data of the roadway, e.g., after evaluation using the machine learning model. In some such implementations, process 800 can include determining a height value or length of each roadway object, e.g., based on pixel data from the image(s). In some implementations, process 800 can include generating an inventory of roadway assets. In some implementations, process 800 can include generating a map (e.g., modifying or overlaying a GIS map) identifying the position of the roadway objects along the roadway. Other post-processing techniques are discussed above.

At step 810, results are presented to a user, e.g., via a user interface. In some implementations, presenting the “results” of steps 802-808 includes displaying a user interface that indicates the number of instances of each identified roadway object. As mentioned above the number of instances of each identified roadway object can be used for inventory management of assets at the roadway. In some such implementations, the number of instances is presented in a GUI or as a report. Additionally, or alternatively, an inventory of assets (e.g., in a database) may be generated or updated. In some implementations, the results can further or alternatively include a user interface that overlays the bounding boxes and/or segmentation masks of one or more objects on the image data (e.g., a copy of a still image or a live video feed). In some such implementations, the user interface includes an indication of the identified object (e.g., a class/label, an identifier, a confidence score, etc.).

### Experimental Results and Examples

Referring generally to FIGS. 9-17B, an experimental setup for testing system 600—along with the results of said testing—are shown, according to some implementations. Specifically, these figures illustrate a proof-of-concept for an enhanced network-level retaining wall inventory using low-cost image-based automatic wall detection technologies. The roadway images on I-75 within metro Atlanta were collected using a “Sensing Vehicle” and were used to evaluate the feasibility of inventorying network retaining walls. The tasks conducted included data collection and evaluation of an AI-based retaining wall detection method.

Data for Testing: Turning first to FIG. 9, the “Sensing Vehicle” used for testing is shown. The “Sensing Vehicle” is a mobile system that is used for collecting 2D and 3D roadway data (e.g., 2D roadway, 2D/3D pavement images, and 3D LiDAR data) for automatic pavement condition evaluation and for the automatic inventory of roadway assets, including pavements, signs, guardrails, retaining walls, noise barriers, rumble strips, etc. Equipped with a high-accuracy global navigation satellite system (GNSS), an inertial navigation system (INS), and 3D laser sensors (crack measurement system, LCMS), the “Sensing Vehicle” serves as a comprehensive data acquisition platform to collect georeferenced, high-resolution, high-accuracy pavement and roadway data. The “Sensing Vehicle” was used to collect high-resolution 2D roadway images for the feasibility study of this project.

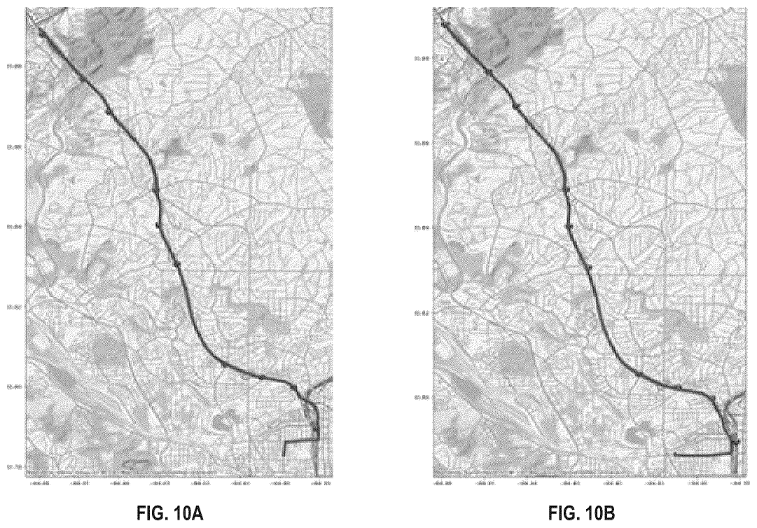

FIGS. 10A and 9B show the selected test sections on I-75. The roadway images with the corresponding GPS coordinates were collected at a fixed interval (e.g., 5 meters). The image resolution was 2448 by 2148 pixels. The roadway images were collected on I-75 from Midtown Atlanta to the interchange of I-385 and I-75. Data was collected over 18.6 survey lane miles in the north and south directions. Three thousand images in the northbound direction and 2,1036 images in the southbound direction were taken (5,1036 total).

FIG. 11 shows three roadway images (left, center, and right views) taken

simultaneously using three cameras mounted on the “Sensing Vehicle.” The right camera captures images on the right side of the roadway, which can better preserve the details of the objects on the roadside (e.g., where the retaining walls are detected and located). Consequently, 600// mainly depends on the right-side roadway images to detect retaining walls. Center images are also utilized in this demo because they capture the lanes more clearly and can also maintain the height information of the retaining walls, which makes them more suitable for measurement.

Automatic retaining wall detection and tracking: As described above with respect to system 600 and/or process 700, automatic retaining wall detection and tracking is performed in two main steps. First, a deep learning-based object detection model detects retaining walls in selected images. Extra data was used to train and fine-tune the object detection model so that it could detect the objects of interest (retaining walls in this study) with flexibility and accuracy. The entire model has over 30 million trainable parameters, making it robust under different circumstances. Specifically, it can detect multiple objects at the same time. Bounding boxes are provided as an output. In practice, results from the object detection model with a low confidence score, e.g., at or exceeding a threshold, can be eliminated.

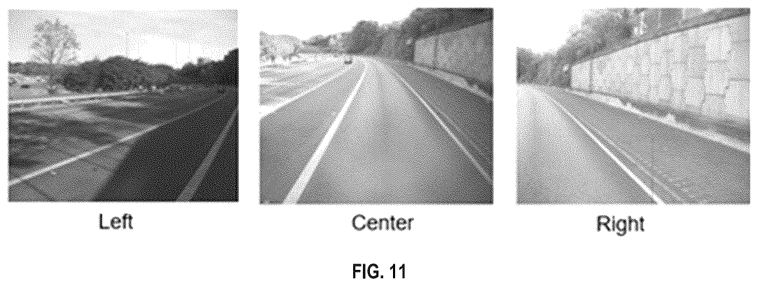

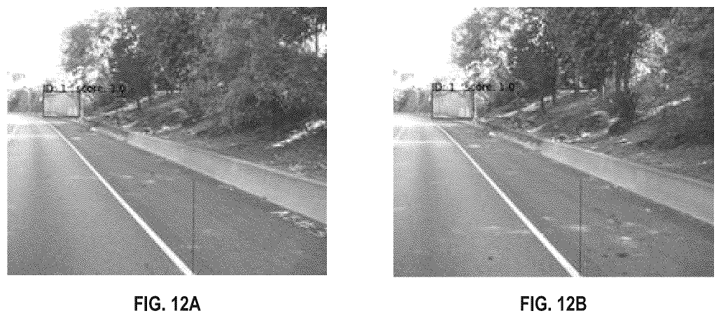

Second, with the detection result, a tracking model associates/clusters the detected retaining walls across different images and assigns to each a unique ID. Specifically, the tracking model associates objects detected by the detection model across different images. For example, the tracking model may take the retaining wall-to-the-camera position and location into account and determine if the new detection shares the same object as the previous detection. After applying the tracking model, the number of retaining walls and the correspondence between the detected retaining walls and image frames in the video log can be counted by assigning unique IDs to the retaining walls. An example of tracking to cluster the same retaining wall between images is shown in FIGS. 12A and 11B.

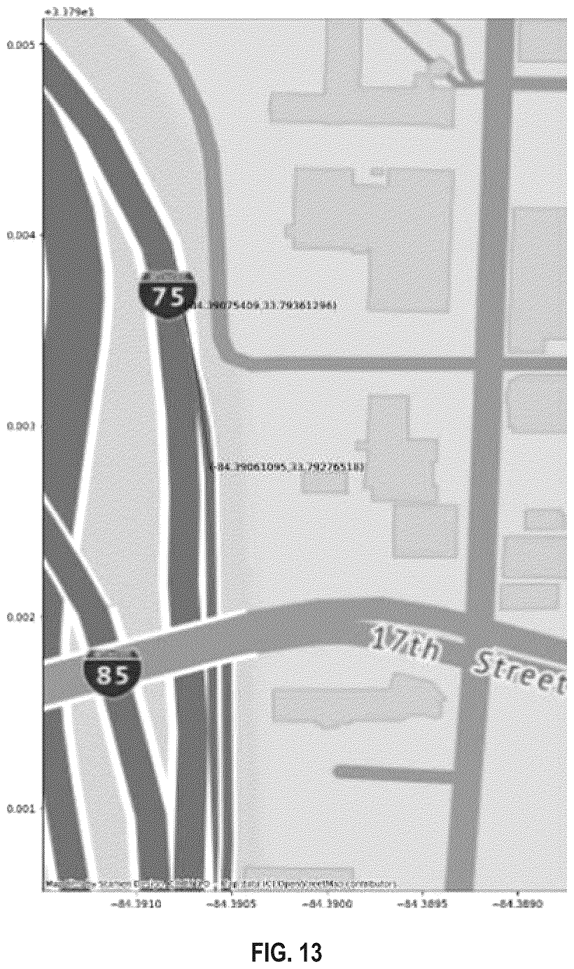

GIS mapping of the detected retaining walls: This operation is configured to generate a GIS map for a detected retaining wall. The method can get the correspondence between the retaining walls from the exemplary detection and tracking algorithms, and image frames can be used to create an arc presenting each retaining wall. Consequently, the method can map the coordinates on a GIS map and join them into a line/arc parallel to the road. FIG. 13 shows an example of a linear retaining wall that has been created and mapped in a GIS map.

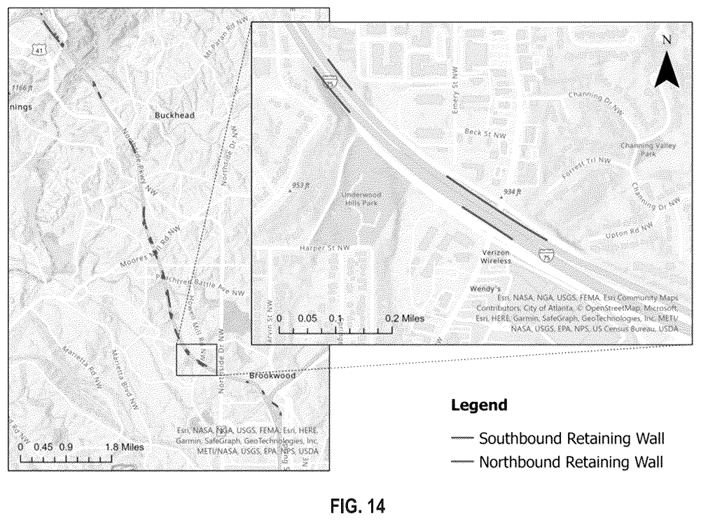

Test outcomes and analyses of the automatic retaining wall detection and tracking method: Based on the application of the automatic retaining wall detection and tracking on the selected test section on I-75, a total of 55 retaining walls were detected, 31 in the northbound and 24 in the southbound lanes. FIG. 14 shows the GIS map of the detected retaining wall locations. Red and blue lines represent the retaining walls in the southbound and the northbound lanes. After manual refinement, there are 22 northbound retaining walls and 18 southbound retaining walls.

Outcome analysis: Overall, the research outcomes on automatic retaining detection and tracking are very promising for implementation. The automatically detected and clustered outcomes of the retaining wall inventory are shown in Table 1 after minor manual refinement. There are 22 northbound retaining walls and 18 southbound retaining walls. 40 retaining walls were detected in the test section and are listed in Table 1. The nine objects identified with an asterisk (*) were classified as retaining walls but required manual confirmation. The three objects identified with a double asterisk (**) were classified as “not retaining walls” and also required manual confirmation. One false negative (FN) case was observed in this proof-of-concept study. The missing retaining wall is located between RW-02 and RW-03. This might not be a bridge/abutment wall but is in between two bridge walls. It is likely caused by uncommon retaining wall texture and pattern.

TABLE 1
Automatically Detected Retaining Walls

| | | | Retaining | | | | | | GEE |
|---|---|---|---|---|---|---|---|---|---|
| | Direction | | Wall | | | | | Est. length | Length |
| N0 | (N/S) | RW_ID | (Y/N) | Begin_x | Begin_y | End_x | End_y | (m) | (m) |
| 1 | N | 1 | Y | −84.3907 | 33.79321 | −84.3908 | 33.79366 | 50 | 58 |
| 2 | N | 2 | Y | −84.3916 | 33.79518 | −84.3931 | 33.79606 | 165 | 178 |
| 3 | N | 3 | N** | −84.3956 | 33.79824 | −84.3959 | 33.79885 | 75 | N/A |
| 4 | N | 8 | Y | −84.412 | 33.80481 | −84.4145 | 33.80617 | 280 | 280 |
| 5 | N | 10 | Y | −84.417 | 33.80801 | −84.4176 | 33.80865 | 90 | 77 |
| 6 | N | 13 | Y | −84.4217 | 33.81673 | −84.4219 | 33.81721 | 55 | 56.6 |
| 7 | N | 15 | Y | −84.4223 | 33.81897 | −84.4224 | 33.81941 | 50 | 50 |
| 8 | N | 16 | Y | −84.4224 | 33.8195 | −84.4227 | 33.82058 | 120 | 127 |
| 9 | N | 17 | Y* | −84.4227 | 33.82084 | −84.4231 | 33.82276 | 215 | 239 |
| 10 | N | 18 | Y | −84.4239 | 33.82552 | −84.4245 | 33.82735 | 210 | 208 |
| 11 | N | 19 | Y | −84.4262 | 33.8315 | −84.4265 | 33.83217 | 80 | 91.5 |
| 12 | N | 20 | Y | −84.4274 | 33.83397 | −84.4276 | 33.83443 | 55 | 54 |
| 13 | N | 21 | Y | −84.4277 | 33.83476 | −84.428 | 33.83526 | 60 | 69 |
| 14 | N | 22 | Y | −84.4291 | 33.83748 | −84.4293 | 33.83799 | 60 | 67.5 |
| 15 | N | 23 | Y | −84.4295 | 33.83856 | −84.4297 | 33.83962 | 120 | 130 |
| 16 | N | 24 | Y | −84.4298 | 33.84016 | −84.4298 | 33.84246 | 255 | 263 |
| 17 | N | 25 | Y | −84.4421 | 33.86843 | −84.4428 | 33.86965 | 150 | 158 |
| 18 | N | 26/27 | Y | −84.4437 | 33.87138 | −84.4442 | 33.87217 | 100 | 108.7 |
| 19 | N | 28 | Y | −84.4528 | 33.88094 | −84.4532 | 33.88137 | 60 | 73 |
| 20 | N | 29 | Y* | −84.4543 | 33.88267 | −84.4546 | 33.88292 | 35 | 61 |
| 21 | N | 30 | N** | −84.4551 | 33.88351 | −84.4552 | 33.88362 | 15 | N/A |
| 22 | N | 31 | Y* | −84.459 | 33.88826 | −84.4591 | 33.88837 | 15 | 40 |
| 23 | S | 1 | Y | −84.4584 | 33.88662 | −84.4583 | 33.88647 | 20 | 110 |
| 24 | S | 2/3/4 | Y | −84.458 | 33.88609 | −84.4564 | 33.88421 | 255 | 374 |
| 25 | S | 5 | Y | −84.4563 | 33.88404 | −84.4547 | 33.88242 | 230 | 255 |
| 26 | S | 6 | N** | −84.4544 | 33.88214 | −84.4541 | 33.88178 | 50 | N/A |
| 27 | S | 7 | Y | −84.4535 | 33.88117 | −84.453 | 33.8806 | 80 | 90 |
| 28 | S | 9 | Y* | −84.4443 | 33.87149 | −84.4441 | 33.87133 | 20 | 120 |
| 29 | S | 10 | Y* | −84.4339 | 33.85816 | −84.4334 | 33.85757 | 75 | 100 |
| 30 | S | 11 | Y* | −84.4332 | 33.85721 | −84.4323 | 33.8554 | 215 | 265 |
| 31 | S | 12 | Y | −84.43 | 33.83887 | −84.4298 | 33.83839 | 55 | 65.5 |
| 32 | S | 13 | Y* | −84.4283 | 33.83497 | −84.4278 | 33.83405 | 110 | 128 |
| 33 | S | 14/15 | Y | −84.4269 | 33.83208 | −84.4261 | 33.8304 | 200 | 214 |
| 34 | S | 16 | Y | −84.4246 | 33.82633 | −84.4244 | 33.82563 | 80 | 110.5 |
| 35 | S | 17 | Y | −84.4234 | 33.82228 | −84.4233 | 33.82179 | 55 | 77.5 |
| 36 | S | 18 | Y | −84.4224 | 33.81752 | −84.4219 | 33.81607 | 165 | 176.5 |
| 37 | S | 19 | Y | −84.4209 | 33.81346 | −84.4198 | 33.81138 | 250 | 262 |
| 38 | S | 20 | Y | −84.4179 | 33.80848 | −84.417 | 33.80754 | 135 | 142 |
| 39 | S | 21/22 | Y* | −84.4141 | 33.80551 | −84.4129 | 33.80483 | 140 | 190 |
| 40 | S | 23 | Y* | −84.4005 | 33.80105 | −84.4 | 33.80097 | 40 | 357 |

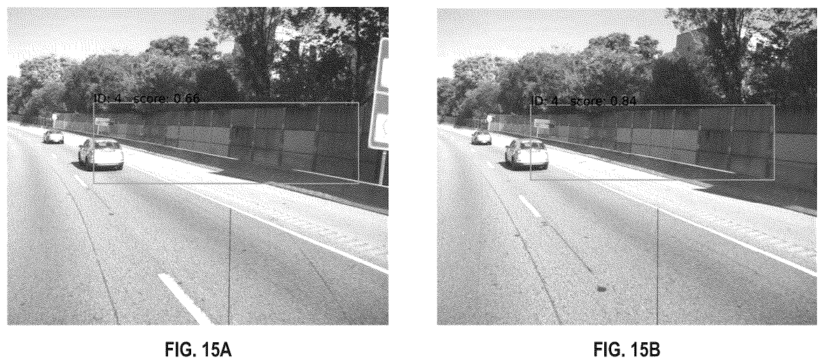

In addition, there were nine FPs, including eight northbound FPs and one southbound FP, based on research outcomes. One such FP is shown in FIGS. 15A and 14B, in which a noise barrier was incorrectly identified as a retaining wall. The FPs in the results originated from the detection process because the tracking model depends on the detection results. The main reason for the misdetection is that some noise barriers have visual features that are very similar to typical retaining walls. If a misdetection occurs continuously across the images, the tracking model would take this object as a genuine retaining wall. However, it is not difficult to eliminate such cases with minor manual refinements.

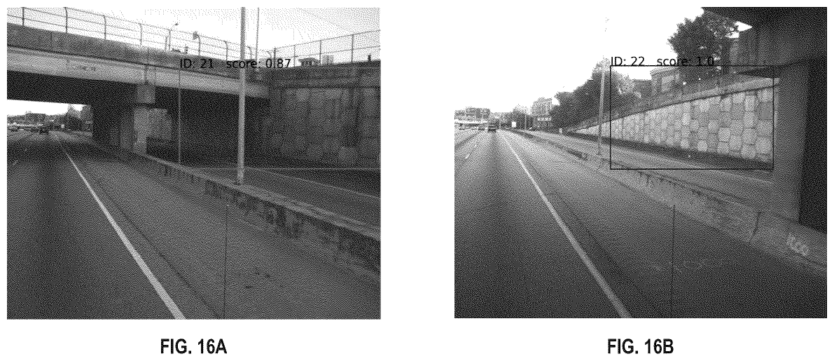

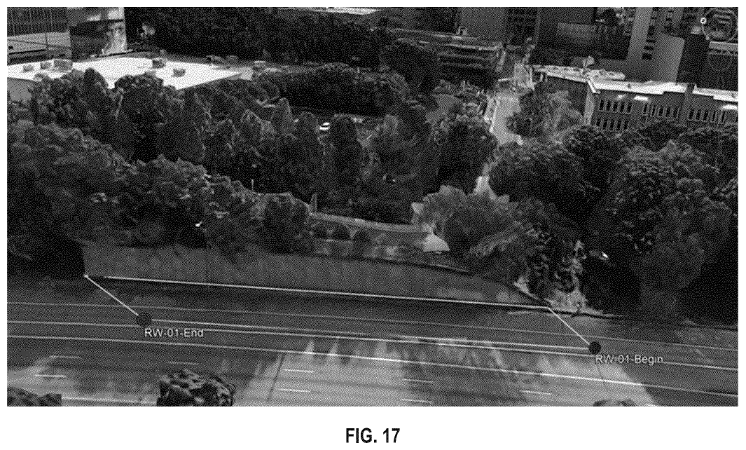

The problem of discontinuity mainly comes from obstacles between the camera and the retaining wall, such as a passing vehicle, bridges, etc. FIGS. 16A and 15B show an example of discontinuity. The obstacles could separate a complete retaining wall into visually disconnected retaining walls. This problem is easily resolved through manual refinement, however. In this example, the outcome was refined by combining the 21^{st} and 22^{nd} retaining walls in the final outcome. The study also estimated the length of each retaining wall based on the number of five-meter interval images. The accuracy of this retaining wall length measurement (e.g., the beginning and end locations) was verified using satellite imagery. FIG. 17 shows the difference between an estimated length and the length measured using satellite imagery.

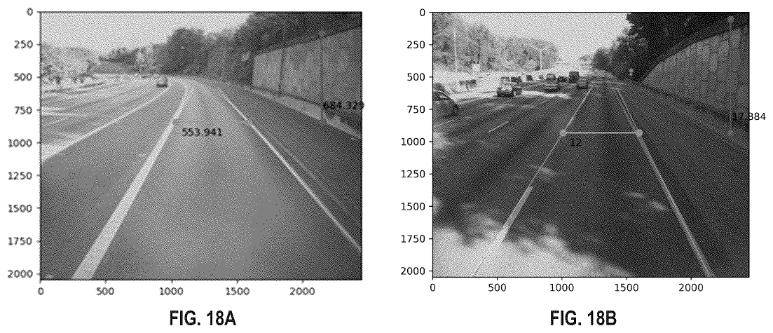

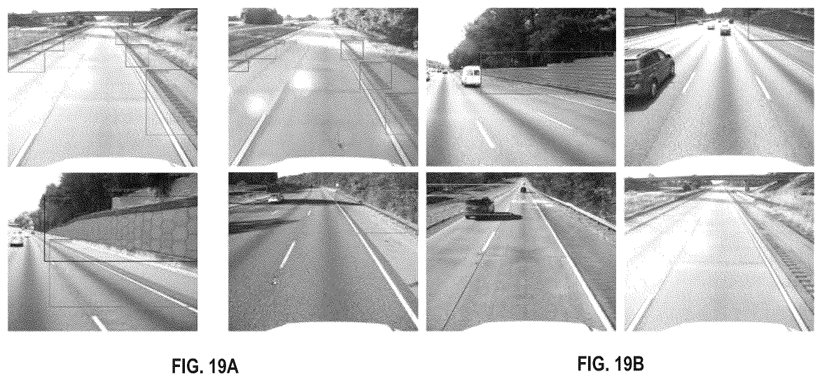

Image-based retaining wall height measurement: In addition, a preliminary test was conducted on a height measurement based on a single 2D image. In particular, the images were taken by the center camera of the “Sensory Vehicle” (e.g., which directly faces the lanes) for the height measurement. This is a semi-automatic process in which a user labels the lowest point, and the highest point of the detected retaining wall; then, the height is automatically calculated. FIG. 18A shows how the height of a retaining wall can be measured semi-automatically using 2D images. In FIGS. 18A, the numbers represent the pixel numbers of the line segments.

Table 2 shows selected retaining walls for evaluating the height measurement accuracy. The height was measured semi-automatically using 2D images, as discussed above. These heights were then evaluated using the heights measured by 3D LiDAR data. In Table 2, h_image refers to the height measured using 2D images. The difference between h_image and h_lidar was also calculated. Based on the preliminary outcome in Table 2, it can be observed that the percentage of errors may vary significantly (from 0.5% to 28.1%). There can be some errors with the measurement due to such things as the distortion of the camera lens, different lane widths, etc., as shown in FIG. 18B.

TABLE 2
Evaluation and Measurement of the Height of Retaining Wall Using 2D Image

| | | | | | | | | Difference = | |
|---|---|---|---|---|---|---|---|---|---|
| | | | | | | | | h_Image − | |
| | | | | | h_image | h_lidar | h_GE, | (h_lidar | Error |
| Test_No | Direction | RW_ID | X | y | (ft) | (ft) | (ft) | or h_GE) | (%) |
| 1 | N | 1 | −84.3907 | 33.79321 | 12.718 | | 17.7 | −4.982 | 28.1% |
| 2 | N | 18 | −84.4239 | 33.82552 | 17.884 | | 17.98 | −0.096 | 0.5% |
| 3 | N | 19 | −84.4262 | 33.8315 | 12.731 | 15.79 | 14.05 | −1.319 | 9.4% |
| 4 | N | 21 | −84.4277 | 33.83476 | 14.778 | | 18.6 | −3.822 | 20.5% |
| 5 | N | 24 | −84.4298 | 33.84016 | 15.906 | | 18.2 | −2.294 | 12.6% |
| 6 | S | 5 | −84.4563 | 33.88404 | 16.69 | | 19.55 | −2.86 | 14.6% |
| 7 | S | 7 | −84.4535 | 33.88117 | 21.239 | | 20.05, +/− 1 | 1.189 | 5.9% |
| 8 | S | 10 | −84.4339 | 33.85816 | 5.421 | 5.12 | 2.8 | 0.301 | 10.8% |
| 9 | S | 18 | −84.4224 | 33.81752 | 17.386 | 18.35 | 17.16 | −0.964 | 5.6% |
| 10 | S | 19 | −84.4209 | 33.81346 | 9.506 | 9.72 | 8.24 | −0.214 | 2.6% |

Summary of experimental results: In summary, it was found that system 600 was quite successful in automatically detecting retaining walls in images for inventory purposes; thus, system 600 (or, generally, process 700 implemented by system 600 or another system) may significantly improve the productivity of the current retaining wall inventory processes. In addition, system 600 and/or process 700 would reduce a large number of manual image reviews or field data collection. For example, more than 85% of the current image review process can be achieved by eliminating the images without retaining walls. With reference to the above-discussed experimental study, system 600 and/or process 700 could reduce the number of images from the original 5,1063 images to 998 images that needed to be reviewed.

The tracking techniques implemented by system 600 have been developed and applied to cluster the images with detected retaining walls and remove noise. These experimental results have demonstrated that such tracking techniques are promising for clustering the final retaining wall inventory. The tracking computation can also determine retaining wall length based on a clustered retaining wall. The locations of the retaining walls can subsequently be displayed on a map using GIS technology, e.g., allowing roadway agencies to review detailed information using the retaining wall locations. Users can use these locations to confirm the correctness of the retaining wall extraction and to further extract the detailed properties of retaining walls.

### Additional Experimentation

Referring generally to FIGS. 19A-21, additional experimental data and results are shown. The data used in this study are digital images acquired by cameras mounted on the “Sensing Vehicle” discussed above. The data was collected along multiple highways in the state of Georgia at a normal highway speed (e.g., 100 km/h). Note that multiple cameras were used during the data collection to capture both the front and side view of the roadway scene from the sensing vehicle, as demonstrated in FIG. 11. With the collected images, six classes of roadway assets, including rumble strip, noise barrier, retaining wall, guardrail, guardrail anchor, and central cable barrier, were manually annotated as the ground truth for training and evaluating the proposed model. As shown in FIGS. 19A and 18B, the ground truth of each roadway asset presented in the image consists of a bounding box, a pixel-level mask, and the class of the roadway asset. Specifically, examples of the collected images with the annotated ground truth are shown in FIG. 19A. To better visualize the six classes of roadway assets, FIG. 19B presents the examples with only the annotations of a single class. The whole dataset is composed of 1707 images in total. In this study, the dataset was randomly split into training and testing datasets in consequence with a ratio of 4:1.

Two experiments were designed and conducted to evaluate the effectiveness of the proposed model(s) based on the prepared data described above. In the first experiment, the proposed GRoIE with GC block (GRoIE-GC) is evaluated by comparison with the baseline model (Mask-RCNN with FPN), including ε₂ attention block (GRoIE-ATT) and non-local block (GRoIE-NL) as the post-processing component. In addition, the proposed model is also compared with other recent variants of Mask-RCNN, including the Mask-RCNN with GC blocks at the backbone (GCNet), deformable convolutional layers at the backbone (DCN), and the path aggregation network after the FPN (PAFPN). In the second experiment, the proposed IoMA-Merging algorithm is evaluated by comparison with the IoU-NMS and IoMA-NMS post-processing algorithms.

The stochastic gradient descent (SGD) optimizer is used to train the models, with a stable learning rate of 0.02, momentum of 0.9, and weight decay of 0.0001. At the beginning of the training, a linear warm-up policy was used to gradually increase the learning rate to the stable learning rate from the initial small learning rate which is only 0.1% of the stable learning rate within the first 500 iterations, to avoid accuracy oscillation at the early stage. At the 16^{th} and 22^{nd} epochs, the learning rate was updated with decay by a factor of 10. In addition, transfer training was used to initialize the backbone weights from pre-trained Res-Net on ImageNet. All the performances from different models were evaluated based on the weights with the best validation performance within a total of 24 epochs.

The loss function used to train the models is defined as Eq. 4:

L=L_{cls}+L_{box}+Lₘₐₛₖ

where the classification loss is a cross-entropy loss across all the classes, and the bounding box loss is a smooth L1 loss taking the deviation between the predicted bounding box coordinates and ground-truth coordinates. The mask loss is an average binary cross-entropy loss between predicted segmentation and ground truth, with respect to the ground-truth class.

Before being fed into the network, all the images in the dataset are normalized and resized to 1224 by 1024. Data augmentation was also used, e.g., such as randomly horizontally flipping normalized and resized input images, which can make models more feasible and adaptable to diverse scenarios. In addition, the data oversampling technique is applied to model training, which can repeat the dataset based on category frequency, and let models pay more attention to classes with fewer samples.

Four metrics were used to evaluate the performance, including mAP(0.5:0.95), precision (IoU@0.5), recall(IoU@0.5), and F-1 score(IoU@0.5). The mAP is a comprehensive metric measuring the overall performance of models by calculating the area under the precision-recall (PR) curve with various IoU thresholds, from 0.5 to 0.95, which is defined in the MS COCO dataset. Precision, recall, and the F-1 score can be formulated as Eqns. 5-8:

$$precision ( Pr ) = \frac{TP}{TP + FP}$$

$$recall ( Re ) = \frac{TP}{TP + FN}$$

$${F}_{1} = \frac{2 \times Pr \times Re}{Pr + Re}$$

where true positives (TPs) are the predictions with IoU greater than a threshold with a ground-truth annotation and if there is more than one prediction satisfying the above criterion, the prediction with the highest score will be regarded as a TP, while false positives (FPs) are the complementary set for TPs in all predictions made by models, and false negatives (FNs) are the complementary set for TPs in all the ground-truth set.

Table 3 and Table 4 present the performances of the implemented models and post-processing algorithms on a test dataset by bounding-box accuracy and segmentation accuracy, respectively.

TABLE 3
Model performance with different post-processing
methods evaluated on bounding box

| Model | Post-processing | mAP | Pr | Re | F₁ |
|---|---|---|---|---|---|
| FPN(baseline) | IoU-NMS | 0.609 | 0.76 | 0.94 | 0.841 |
| | IoMA-NMS | 0.604 | 0.835 | 0.929 | 0.88 |
| | IoMA-Merging | 0.599 | 0.836 | 0.923 | 0.877 |
| Dconv | IoU-NMS | 0.558 | 0.628 | 0.948 | 0.755 |
| | IoMA-NMS | 0.551 | 0.777 | 0.928 | 0.846 |
| | IoMA-Merging | 0.534 | 0.786 | 0.906 | 0.842 |
| GCB | IoU-NMS | 0.568 | 0.603 | 0.949 | 0.738 |
| | IoMA-NMS | 0.561 | 0.764 | 0.925 | 0.837 |
| | IoMA-Merging | 0.545 | 0.775 | 0.898 | 0.832 |
| PAFPN | IoU-NMS | 0.63 | 0.764 | 0.953 | 0.848 |
| | IoMA-NMS | 0.623 | 0.841 | 0.941 | 0.888 |
| | IoMA-Merging | 0.616 | 0.844 | 0.935 | 0.887 |
| GRoIE-ATT | IoU-NMS | 0.62 | 0.788 | 0.939 | 0.857 |
| | IoMA-NMS | 0.618 | 0.852 | 0.932 | 0.89 |
| | IoMA-Merging | 0.613 | 0.849 | 0.923 | 0.884 |
| GRoIE-NL | IoU-NMS | 0.627 | 0.784 | 0.944 | 0.856 |
| | IoMA-NMS | 0.623 | 0.84 | 0.935 | 0.885 |
| | IoMA-Merging | 0.623 | 0.84 | 0.932 | 0.883 |
| GRoIE-GC | IoU-NMS | 0.637 | 0.807 | 0.947 | 0.871 |
| | IoMA-NMS | 0.632 | 0.854 | 0.934 | 0.892 |
| | IoMA-Merging | 0.631 | 0.86 | 0.933 | 0.895 |

TABLE 4
Model performance with different post-processing
methods evaluated on segmentation

| Model | Post-processing | mAP | Pr | Re | F₁ |
|---|---|---|---|---|---|
| FPN(baseline) | IoU-NMS | 0.57 | 0.766 | 0.948 | 0.847 |
| | IoMA-NMS | 0.566 | 0.847 | 0.943 | 0.893 |
| | IoMA-Merging | 0.562 | 0.849 | 0.938 | 0.891 |
| Dconv | IoU-NMS | 0.497 | 0.625 | 0.943 | 0.752 |
| | IoMA-NMS | 0.492 | 0.777 | 0.928 | 0.846 |
| | IoMA-Merging | 0.481 | 0.798 | 0.92 | 0.855 |
| GCB | IoU-NMS | 0.507 | 0.601 | 0.945 | 0.735 |
| | IoMA-NMS | 0.502 | 0.769 | 0.931 | 0.842 |
| | IoMA-Merging | 0.492 | 0.79 | 0.917 | 0.848 |
| PAFPN | IoU-NMS | 0.581 | 0.765 | 0.954 | 0.849 |
| | IoMA-NMS | 0.578 | 0.847 | 0.948 | 0.894 |
| | IoMA-Merging | 0.574 | 0.852 | 0.943 | 0.895 |
| GRoIE-ATT | IoU-NMS | 0.576 | 0.795 | 0.948 | 0.865 |
| | IoMA-NMS | 0.575 | 0.862 | 0.943 | 0.901 |
| | IoMA-Merging | 0.571 | 0.864 | 0.939 | 0.9 |
| GRoIE-NL | IoU-NMS | 0.58 | 0.789 | 0.95 | 0.862 |
| | IoMA-NMS | 0.578 | 0.85 | 0.946 | 0.895 |
| | IoMA-Merging | 0.578 | 0.852 | 0.946 | 0.897 |
| GRoIE-GC | IoU-NMS | 0.587 | 0.812 | 0.953 | 0.877 |
| | IoMA-NMS | 0.583 | 0.867 | 0.949 | 0.906 |
| | IoMA-Merging | 0.584 | 0.873 | 0.948 | 0.909 |

The effectiveness of GRoIE-GC: As shown in Tables 3 and 5, the GRoIE-GC model achieved the best performance on both bounding-box detection and pixel-level segmentation with the highest mAP, precision, and F-1 scores. Compared with the baseline Mask-RCNN, the proposed model achieved a 2.8% improvement on detection mAP and a 1.70% improvement on segmentation mAP. Despite the recall rate, the GRoIE-GC model achieved the highest F-1 scores both in detection and segmentation, 3.0% higher than the baseline.

The results show that all models with GRoIE achieved better performance than the baseline model, which demonstrates that considering multi-scale features in the RoI extractor is critical in roadway asset detection and segmentation. Among the models with GRoIE, the proposed GRoIE-GC model achieved the best performance in both detection and segmentation. This shows that the “key content only” attention is the most suitable attention factor for the RoI extractor in this study. This phenomenon also demonstrates that “key content only” attention is effective in extracting useful semantic information from different layers, diminishing distraction from key contents and relative positions, and further better modeling the global context, which is critical for the model to achieve improved visual recognition performance.

Among the other variants of Mask-RCNN, models with GCB and DCN in the backbone did not achieve better performance than the baseline. These models achieved a high recall score, however, with a low precision score. DCN can be viewed as a variant of spatial attention mechanisms in that it was designed to focus on certain parts of the input, by augmenting the spatial sampling locations according to object scales. GCB is a typical instantiation with an attention mechanism in the backbone. It was found that such approaches provide a feature map that is more sensitive to plausible objects. That is, this feature map is easily affected by scale variance and therefore biased at an early stage of the model structure, which is not beneficial to roadway asset detection and segmentation with more FP cases being generated. In addition, PAFPN also has a fair performance in this study. PAFPN uses a bottom-up path argumentation technique to shorten the information path in different FPN layers. In other words, it aggregates information from each FPN layer so that richer semantic information leads to better prediction, which is an idea shared with GRoIE. Still, the GRoIE technique outperformed PAFPN in this study, which shows that the aggregation of features in the RoI extractor is more beneficial for roadway asset detection and segmentation.

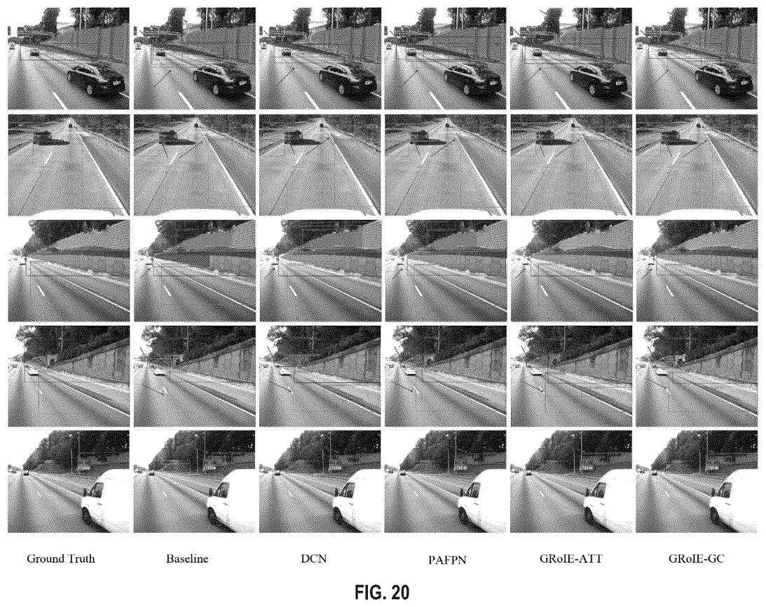

FIG. 20 presents cases with ground-truth annotations from the testing dataset and the corresponding detection and segmentation results from different models. With reference to the ground truth annotations (left-most column), the most salient advantage of the proposed GRoIE-GC model is that it decreased FP predictions. This indicates that the proposed model is more robust to scale and shape variance. On the other hand, other models are more susceptible to such changes among images, making them less capable of precisely capturing the instances of roadway assets. For example, as shown in the first row of FIG. 20, the proposed model (the right-most column) correctly segmented one retaining wall, one noise barrier, and one rumble strip (same as the ground truth) while the other modem over-counted the objects. Consequently, the proposed model will improve the accuracy of asset inventory in terms of quantity estimation. Nevertheless, there are two failure cases shown in FIG. 20 (last two rows). In these two examples, all of the selected models produced overlapping predictions, which can be alleviated by the post-processing steps described herein.

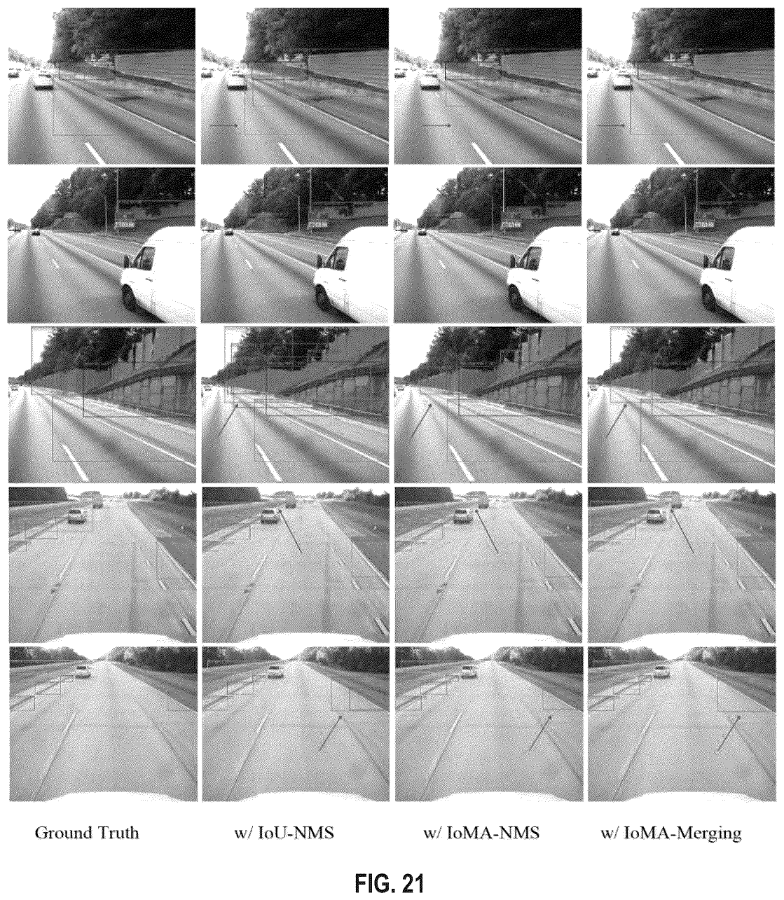

The effectiveness of IoMA-Merging: From Tables 3 and 4, the benefit of replacing IoU with IoMA, including IoMA-NMS and IoMA-Merging, can be revealed by the notable increase in precision and F-1 score on all models. The advantage of IoMA over IoU is also shown in FIG. 21, in which the overlapping boxes and masks are largely suppressed by IoMA-NMS and IoMA-Merging but not IoU-NMS. However, a slight decrease in recall can also be observed on IoMA-based algorithms, which is mainly caused by a few FNs being introduced when suppressing the overlapping predictions. An example can be seen in the fourth image in the fifth row (the rumble strip on the right) in FIG. 21.

Comparing the proposed IoMA-Merging and IoMA-NMS, there is no significant improvement in metric values. However, the most significant advantage of IoMA-Merging is that it maintains the completeness of the predicted bounding box and segmentation mask of each instance. As shown in the third row of FIG. 21, IoMA-NMS detected the noise barrier with multiple boxes and masks, each covering a portion of the instance. On the other hand, IoMA-Merging detected the noise barrier with a single and complete detection. In summary, the proposed IoMA-Merging algorithm can effectively suppress FP cases and maintain the completeness of the detection on each instance. Although these advantages do not significantly reflect on all the metric values, they are critical for subsequent visualization and analysis of roadway assets, such as inventory building. This demonstrates the practical contribution of the proposed IoMA-Merging algorithm.

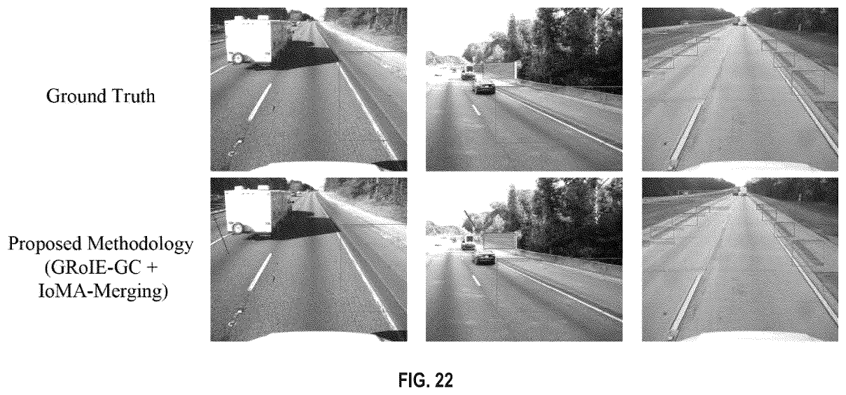

Error analysis: As shown in the last two columns of FIG. 21, the unsolved FPs mainly come from redundant detections on a single instance of the roadway asset, which are not eliminated by the IoMA-merging algorithm because they are merged with TPs due to the relatively high classification score. To resolve this issue, fine-tuning can be conducted on the anchor ratios of the RPN by clustering, which could help with generating bounding box proposals that better fit the roadway assets. On the other hand, the unsolved FN cases include roadway assets that are hard to identify due to factors including low resolution, extreme local exposure, and long distance between itself and the camera, as shown in FIG. 22. This problem can be addressed by training the model with more data or advanced data augmentation to improve the generalization capability of the model.

Table 5 shows the F-1 of the proposed model on each class in the testing dataset, illustrating the improvements of the disclosed techniques in each class compared with the baseline.

TABLE 5
Per-class performance from the proposed methodology

| | | Central | | | | | |
|---|---|---|---|---|---|---|---|
| | | Cable | Rumble | Retaining | Noise | | Guard- |
| Methodology | | Barrier | Strip | Wall | Barrier | Anchor | rail |
| bbox | base | 0.876 | 0.872 | 0.848 | 0.724 | 0.800 | 0.843 |
| | new | 0.942 | 0.898 | 0.902 | 0.857 | 0.857 | 0.906 |
| segm | base | 0.889 | 0.884 | 0.834 | 0.792 | 0.800 | 0.834 |
| | new | 0.957 | 0.916 | 0.902 | 0.863 | 0.857 | 0.926 |

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on a designer's choice. All such variations are within the scope of the disclosure. Likewise, software implementations could be accomplished with standard programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A system comprising:
at least one processor; and
memory having instructions stored thereon that, when executed by the at least one processor, cause the system to:
obtain image data of a physical scene having a roadway, wherein the image data comprises still images or video frames;
detect, by executing a trained machine learning model, a roadway object in the image data, including a contiguous roadway object that spans across a plurality of the still images or video frames, the roadway object detected from among a set of predefined roadway objects on which the trained machine learning model is trained to detect;
determine, by executing the trained machine learning model, a position of the detected roadway object in the plurality of still images or video frames, including of the contiguous roadway object;
join a first determined position of the roadway object in a first one of the plurality of still images or video frames and a second determined position of the roadway object in a second one of the plurality of still images or video frames to generate a multi-frame representation of the roadway object;
determine a number of instances of the roadway object over a predefined region of the roadway; and
output, via a user interface, an indication of the determined number of instances of the roadway object, wherein the determined number of instances is used for inventory management of assets at the roadway.

2. The system of claim 1, wherein the joining the first determined position and the second determined position includes to:
detect a discontinuity in the multi-frame representation of the roadway object between the first one of the plurality of still images or video frames and the second one of the plurality of still images or video frames; and
remove a still image or video frame associated with the discontinuity.

3. The system of claim 1, wherein the instructions further cause the system to:
determine a height value of the roadway object from the image data; and
output, via the user interface, an indication of the determined height value, wherein the determined height value is used for the inventory management of assets at the roadway.

4. The system of claim 1, wherein the trained machine learning model is configured to detect, classify, and segment the set of predefined roadway objects from the image data, the trained machine learning model comprising:
a plurality of convolutional layers configured to extract contextual features from the image data at a plurality of spatial resolutions, the plurality of convolutional layers comprising a backbone portion and a feature pyramid network (FPN) portion;
a generic region-of-interest extractor (GRoIE) configured to aggregate an output of the plurality of convolutional layers for region-of-interest (RoI) extraction, the GRoIE comprising a global context (GC) block for instantiation based on a key content only attention factor;
a bounding box head configured to predict coordinates of a bounding box and a corresponding class for any detected roadway objects based on an output of the GRoIE; and
a segmentation head configured to generate a pixel-wise segmentation mask for any detected roadway objects.

5. The system of claim 4, wherein the GRoIE comprises:
a plurality of pooling layers in which each pooling layer of the plurality of pooling layers connects to an output of the FPN portion;
a plurality of embedding layers in which each embedding layer of the plurality of embedding layers is connected to a pooling layer of the plurality of pooling layers; and
an aggregation layer that is connected to outputs of the plurality of embedding layers.

6. The system of claim 4, wherein the instructions further cause the system to:
merge two or more bounding boxes or segmentation masks associated with a same detected roadway object using an IoMA-Merging operation to suppress false positives.

7. The system of claim 6, wherein the IoMA-Merging operation comprises to:
determine a difference between a classification score of a candidate bounding box and a classification score of a best-score candidate bounding box is within a first predefined threshold; and
remove the candidate bounding box if the difference is less than a second predefined threshold, wherein the first predefined threshold is greater than the second predefined threshold.

8. The system of claim 4, wherein the GC block computes a weight applied to a sum, for the key content only attention factor, of a convolution operation between an embedded Gaussian and a given key element.

9. A method to automate inventory management of roadway assets, the method comprising:
obtaining, by a processing device, image data of a physical scene having a roadway, wherein the image data comprises still images or video frames;
detecting, by the processing device, by executing a trained machine learning model, a roadway object in the image data, including a contiguous roadway object that spans across a plurality of the still images or video frames, the roadway object detected from among a set of predefined roadway objects on which the trained machine learning model is trained to detect;
determining, by the processing device, by executing the trained machine learning model, a position of the detected roadway object in the plurality of still images or video frames, including of the contiguous roadway object;
joining, by the processing device, a first determined position of the roadway object in a first one of the plurality of still images or video frames and a second determined position of the roadway object in a second one of the plurality of still images or video frames to generate a multi-frame representation of the roadway object;
determining, by the processing device, a number of instances of the roadway object over a predefined region of the roadway; and
output, by the processing device, via a user interface, an indication of the determined number of instances of the roadway object, wherein the determined number of instances is used for inventory management of assets at the roadway.

10. The method of claim 9, wherein the joining the first determined position and the second determined position includes:
detecting, by the processing device, a discontinuity in the multi-frame representation of the roadway object between the first one of the plurality of still images or video frames and the second one of the plurality of still images or video frames; and
removing, by the processing device, a still image or video frame associated with the discontinuity.

11. The method of claim 9, further comprising:
determining, by the processing device, a height value of the roadway object from the image data; and
outputting, by the processing device, via the user interface, an indication of the determined height value, wherein the determined height value is used for the inventory management of assets at the roadway.

12. The method of claim 9, wherein the trained machine learning model is configured to detect, classify, and segment the set of predefined roadway objects from the image data, the trained machine learning model comprising:
a plurality of convolutional layers configured to extract contextual features from the image data at a plurality of spatial resolutions, the plurality of convolutional layers comprising a backbone portion and a feature pyramid network (FPN) portion;
a generic region-of-interest extractor (GRoIE) configured to aggregate an output of the plurality of convolutional layers for region-of-interest (RoI) extraction, the GRoIE comprising a global context (GC) block for instantiation based on a key content only attention factor;
a bounding box head configured to predict coordinates of a bounding box and a corresponding class for any detected roadway objects based on an output of the GRoIE; and
a segmentation head configured to generate a pixel-wise segmentation mask for any detected roadway objects.

13. The method of claim 12, wherein the GRoIE comprises:
a plurality of pooling layers in which each pooling layer of the plurality of pooling layers connects to an output of the FPN portion;
a plurality of embedding layers in which each embedding layer of the plurality of embedding layers is connected to a pooling layer of the plurality of pooling layers; and
an aggregation layer that is connected to outputs of the plurality of embedding layers.

14. The method of claim 12, further comprising:
merging, by the processing device, two or more bounding boxes or segmentation masks associated with a same detected roadway object using an IoMA-Merging operation to suppress false positives.

15. The method of claim 14, wherein the IoMA-Merging operation comprises:
determining, by the processing device, a difference between a classification score of a candidate bounding box and a classification score of a best-score candidate bounding box is within a first predefined threshold; and
removing, by the processing device, the candidate bounding box if the difference is less than a second predefined threshold, wherein the first predefined threshold is greater than the second predefined threshold.

16. The method of claim 12, wherein the GC block computes a weight applied to a sum, for the key content only attention factor, of a convolution operation between an embedded Gaussian and a given key element.

17. A non-transitory computer readable medium having instructions stored thereon that, when executed by at least one processor, cause a device to:
obtain image data of a physical scene having a roadway, wherein the image data comprises still images or video frames;
detect, by executing a trained machine learning model, a roadway object in the image data, including a contiguous roadway object that spans across a plurality of the still images or video frames, the roadway object detected from among a set of predefined roadway objects on which the trained machine learning model is trained to detect;
determine, by executing the trained machine learning model, a position of the detected roadway object in the plurality of still images or video frames, including of the contiguous roadway object;
join a first determined position of the roadway object in a first one of the plurality of still images or video frames and a second determined position of the roadway object in a second one of the plurality of still images or video frames to generate a multi-frame representation of the roadway object;
determine a number of instances of the roadway object over a predefined region of the roadway; and
output, via a user interface, an indication of the determined number of instances of the roadway object, wherein the determined number of instances is used for inventory management of assets at the roadway.

18. The computer readable medium of claim 17, wherein the joining the first determined position and the second determined position includes to:
detect a discontinuity in the multi-frame representation of the roadway object between the first one of the plurality of still images or video frames and the second one of the plurality of still images or video frames; and
remove a still image or video frame associated with the discontinuity.

19. The computer readable medium of claim 17, wherein the instructions further cause the device to:
determine a height value of the roadway object from the image data; and
output, via the user interface, an indication of the determined height value, wherein the determined height value is used for the inventory management of assets at the roadway.

20. The computer readable medium of claim 17, wherein the trained machine learning model is configured to detect, classify, and segment the set of predefined roadway objects from the image data, the trained machine learning model comprising:
a plurality of convolutional layers configured to extract contextual features from the image data at a plurality of spatial resolutions, the plurality of convolutional layers comprising a backbone portion and a feature pyramid network (FPN) portion;
a generic region-of-interest extractor (GRoIE) configured to aggregate an output of the plurality of convolutional layers for region-of-interest (RoI) extraction, the GRoIE comprising a global context (GC) block for instantiation based on a key content only attention factor;
a bounding box head configured to predict coordinates of a bounding box and a corresponding class for any detected roadway objects based on an output of the GRoIE; and
a segmentation head configured to generate a pixel-wise segmentation mask for any detected roadway objects.
